(19) United States
(12) Patent Application Publication
(10) Pub. No.: US 2025/0385721 A1
(43) Pub. Date: Dec. 18, 2025

(54) BEAM MANAGEMENT IN A JPTA SYSTEM WITH MULTIPLE COMPONENT CARRIERS

(71) Applicant: Samsung Electronics Co., Ltd., Suwon-si (KR)

(72) Inventors: Xinliang Zhang, Plano, TX (US); Ahmad AlAmmouri, Richardson, TX (US); Young Han Nam, Plano, TX (US)

(21) Appl. No.: 19/174,772

(22) Filed: Apr. 9, 2025

Related U.S. Application Data
(60) Provisional application No. 63/661,384, filed on Jun. 18, 2024.

(51) Int. Cl. H04B 7/06; H04L 5/00

(52) U.S. Cl. CPC H04B 7/0626; H04B 7/0617; H04B 7/06958; H04L 5/001

(57) ABSTRACT

Apparatuses and methods for beam management in joint phase and time array (JPTA) system with multiple component carriers. A method performed by a user equipment (UE) receiving configuration information related to frequency-selective channel state information reference signals (CSI-RSs) in a set of orthogonal frequency-division multiplexing (OFDM) symbols across component carriers (CCs) for a JPTA beam measurement and integrated channel state information (CSI) report and receiving, based on the configuration information, the frequency-selective CSI-RSs in the set of OFDM symbols across the CCs. The method further includes measuring, based on the configuration information, the frequency-selective CSI-RSs across the CCs, generating the integrated CSI report that includes information associated with measurements of the frequency-selective CSI-RSs across the CCs, and transmitting the integrated CSI report.

### CROSS-REFERENCE TO RELATED AND CLAIM OF PRIORITY

The present application claims priority under 35 U.S.C. § 119(e) to U.S. Provisional Patent Application No. 63/661,384 filed on Jun. 18, 2024, which is hereby incorporated by reference in its entirety.

### TECHNICAL FIELD

The present disclosure relates generally to wireless communication systems and, more specifically, the present disclosure is related to apparatuses and methods for beam management in joint phase and time array (JPTA) system with multiple component carriers.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam management in JPTA system with multiple component carriers.

In one embodiment, a user equipment (UE) is provided. The UE includes a transceiver configured to receive configuration information related to frequency-selective channel state information reference signals (CSI-RSs) in a set of orthogonal frequency-division multiplexing (OFDM) symbols across component carriers (CCs) for a JPTA beam measurement and integrated channel state information (CSI) report and receive, based on the configuration information, the frequency-selective CSI-RSs in the set of OFDM symbols across the CCs. The UE further includes a processor operably coupled with the transceiver. The processor is configured to measure, based on the configuration information, the frequency-selective CSI-RSs across the CCs and generate the integrated CSI report that includes information associated with measurements of the frequency-selective CSI-RSs across the CCs. The transceiver is further configured to transmit the integrated CSI report.

In another embodiment, a base station (BS) is provided. The BS includes a processor and a transceiver operably coupled with the processor. The transceiver is configured to transmit configuration information related to frequency-selective CSI-RSs in a set of OFDM symbols across CCs for a JPTA beam measurement and integrated CSI report, transmit, according to the configuration information, the frequency-selective CSI-RSs in the set of OFDM symbols across the CCs, and receive the integrated CSI report that includes measurement information associated with the frequency-selective CSI-RSs across the CCs.

In yet another embodiment, a method performed by a UE is provided. The method includes receiving configuration information related to frequency-selective CSI-RSs in a set of OFDM symbols across CCs for a JPTA beam measurement and integrated CSI report and receiving, based on the configuration information, the frequency-selective CSI-RSs in the set of OFDM symbols across the CCs. The method further includes measuring, based on the configuration information, the frequency-selective CSI-RSs across the CCs, generating the integrated CSI report that includes information associated with measurements of the frequency-selective CSI-RSs across the CCs, and transmitting the integrated CSI report.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example procedure for beam management according to embodiments of the present disclosure;

FIG. 7 illustrates a diagram of an example channel state information reference signal (CSI-RS) measurement and report configuration according to embodiments of the present disclosure;

FIG. 8 illustrates an example of a hybrid beamforming structure according to embodiments of the present disclosure;

FIG. 9 illustrates an example of a JPTA beamforming according to embodiments of the present disclosure;

FIG. 10 illustrates an example of a JPTA circuit according to embodiments of the present disclosure;

FIG. 11 illustrates a diagram of example angular relationships for candidate CSI-RS beams according to embodiments of the present disclosure;

FIG. 12 illustrates a diagram of time division multiplexed (TDMed) CSI-RS beams according to embodiments of the present disclosure;

FIG. 13 illustrates an example of a timeline for triggering, transmission, and reporting according to embodiments of the present disclosure;

FIG. 14 illustrates an example of a timeline for triggering, transmission, and reporting according to embodiments of the present disclosure;

FIG. 15 illustrates a diagram of TDMed and frequency division multiplexed (FDMed) CSI-RS beams according to embodiments of the present disclosure;

FIG. 16 illustrates an example of a timeline for triggering, transmission, and reporting according to embodiments of the present disclosure;

FIG. 17 illustrates a flow diagram for an example UE procedure for transmitting an integrated CSI report according to embodiments of the present disclosure;

FIG. 18 illustrates a diagram of an example trigger configuration according to embodiments of the present disclosure;

FIG. 19 illustrates a diagram of an example trigger configuration according to embodiments of the present disclosure;

FIG. 20 illustrates a diagram of an example trigger configuration according to embodiments of the present disclosure;

FIG. 21 illustrates a diagram of an example trigger configuration according to embodiments of the present disclosure;

FIG. 22 illustrates a diagram of example CSI report configurations according to embodiments of the present disclosure;

FIG. 23 illustrates a diagram of an example trigger configuration according to embodiments of the present disclosure;

FIG. 24 illustrates a diagram of an example CSI report trigger configuration according to embodiments of the present disclosure;

FIG. 25 illustrates a diagram of an example trigger configuration according to embodiments of the present disclosure;

FIG. 26 illustrates a diagram of example CSI report group configurations according to embodiments of the present disclosure;

FIG. 27 illustrates a diagram of example CSI report group configurations according to embodiments of the present disclosure;

FIG. 28 illustrates a diagram of example CSI report group configurations according to embodiments of the present disclosure;

FIG. 29 illustrates a diagram of example CSI report group configurations according to embodiments of the present disclosure;

FIG. 30 illustrates a diagram of an example CSI report list configuration according to embodiments of the present disclosure;

FIG. 31 illustrates a diagram of an example CSI report list configuration according to embodiments of the present disclosure;

FIG. 32 illustrates a diagram of an example CSI report list configuration according to embodiments of the present disclosure; and

FIG. 33 illustrates an example method performed by a UE in a wireless communication system according to embodiments of the present disclosure.

### DETAILED DESCRIPTION

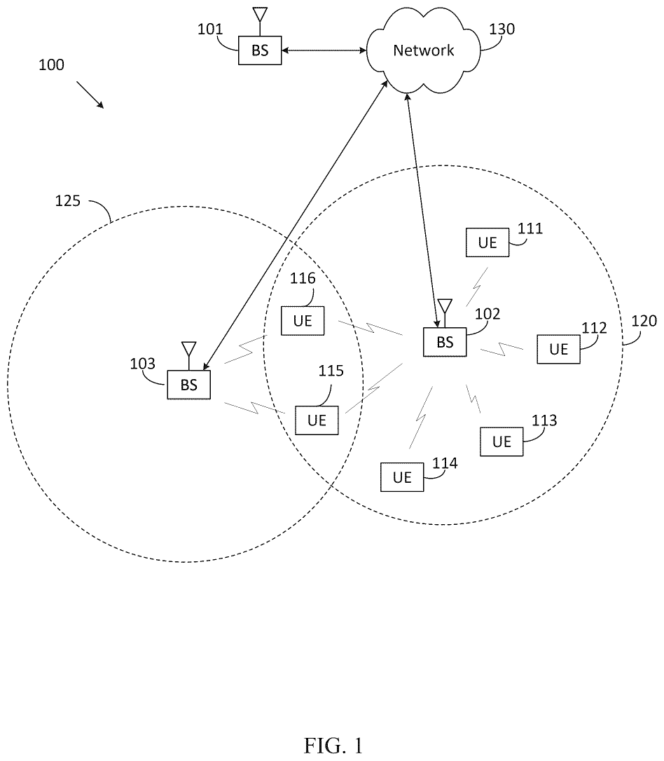

FIGS. 1-33, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.331: “NR; Radio Resource Control (RRC) protocol specification;” [REF2] V. Boljanovic et al., “Fast Beam Training with True-Time-Delay Arrays in Wideband Millimeter-Wave Systems,” in IEEE Transactions on Circuits and Systems I: Regular Papers, vol. 68, no. 4, pp. 1727-1739, April 2021, DOI: 10.1109/TCSI.2021.3054428; [REF3] I. Jain, et al., “Towards Flexible Frequency-Dependent mmWave Multi-Beamforming” International Workshop on Mobile Computing Systems and Applications (HotMobile '23), 2023, doi:10.1145/3572864.3581579; [REF4]A. AlAmmouri et al., “Extending Uplink Coverage of mmWave and Terahertz Systems Through Joint Phase-Time Arrays,” in IEEE Access, vol. 10, pp. 88872-88884, 2022, DOI: 10.1109/ACCESS.2022.3200334; [REF5]V. V. Ratnam et al., “Joint Phase-Time Arrays: A Paradigm for Frequency-Dependent Analog Beamforming in 6G,” in IEEE Access, vol. 10, pp. 73364-73377, 2022, DOI: 10.1109/ACCESS.2022.3190418; [REF6]U.S. Patent Application Pub. No. 2023/0362671 filed Apr. 24, 2023; and [REF7]T. Forbes, B. Magstadt, J. Moody, A. Suchanek, and S. Nelson, “A 0.2-2 GHz Time-Interleaved Multi-Stage Switched-Capacitor Delay Element Achieving 448.6 ns Delay and 330 ns/mm2 Area Efficiency,” in 2022 IEEE Radio Frequency Integrated Circuits Symposium (RFIC), June 2022, pp. 135-138.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam management in JPTA system with multiple component carriers. In certain embodiments, one or more of the BSs 101-103 include circuitry, programing, or a combination thereof to support beam management in JPTA system with multiple component carriers.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

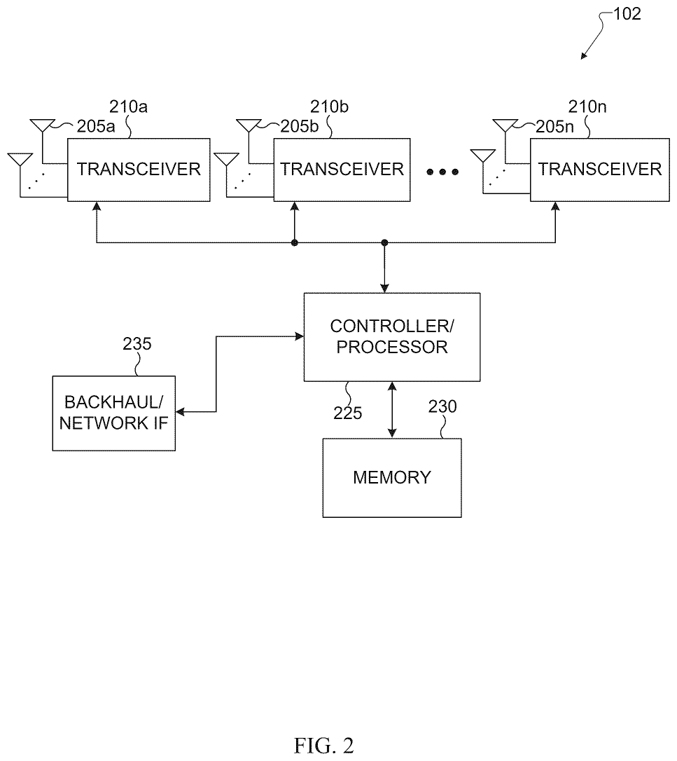

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for beam management in JPTA system with multiple component carriers. Any of a wide variety of other functions could be supported in the gNB 102 by the controller/processor 225.

The controller/processor 225 is also capable of executing programs and other processes resident in the memory 230, such as processes to trigger beam management in JPTA system with multiple component carriers. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

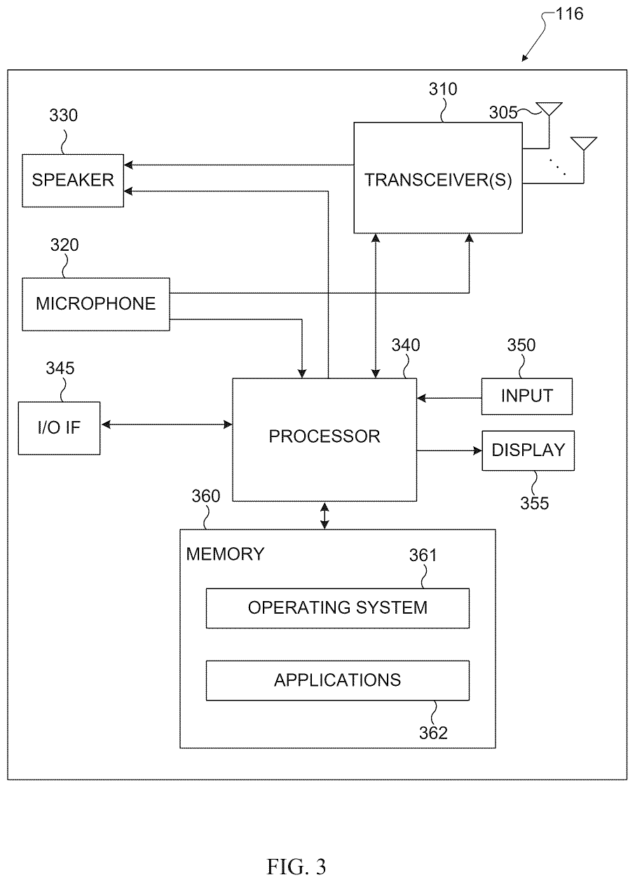

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam management in JPTA system with multiple component carriers as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

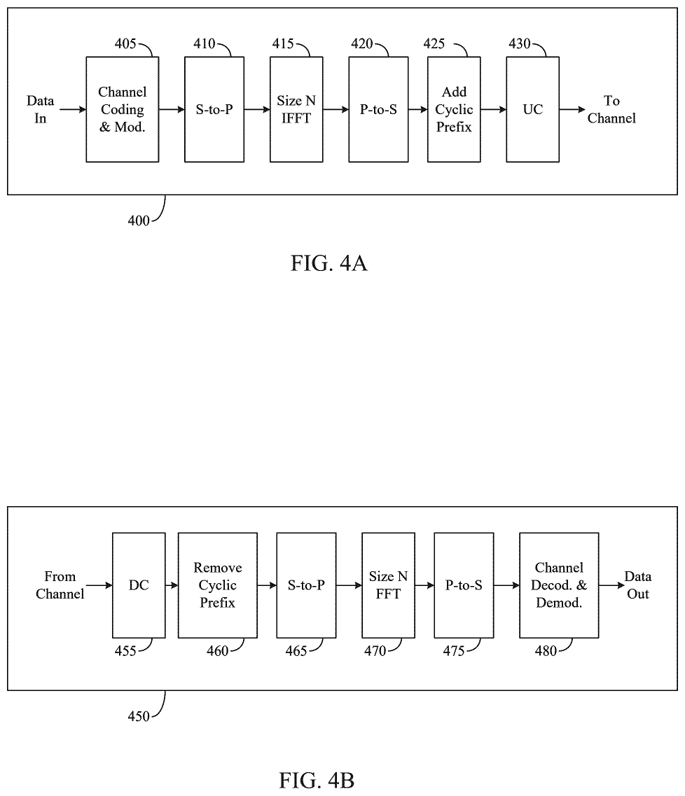

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for beam management in JPTA system with multiple component carriers as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

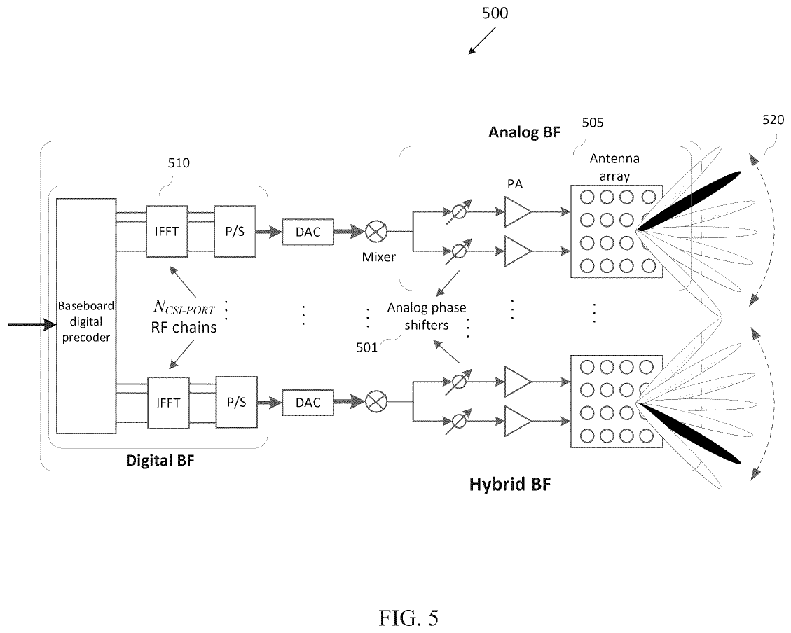

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

In the 5G system, Hybrid frequency-shift keying (FSK) and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

Beam management optimizes the selection of radio beams to ensure efficient and effective wireless communication between the base station (BS) and the user equipment (UE). Through dynamically selecting the best beam of set of beams for communication based on real-time conditions such as user location, mobility and surrounding environment, it ensures that the UE has an improved chance to the optimal beams. Beam refinement, by fine-tuning the beam characteristic (such as beam width, direction, power, etc.), adapt to small changes in the wireless channel ensuring the best connection quality.

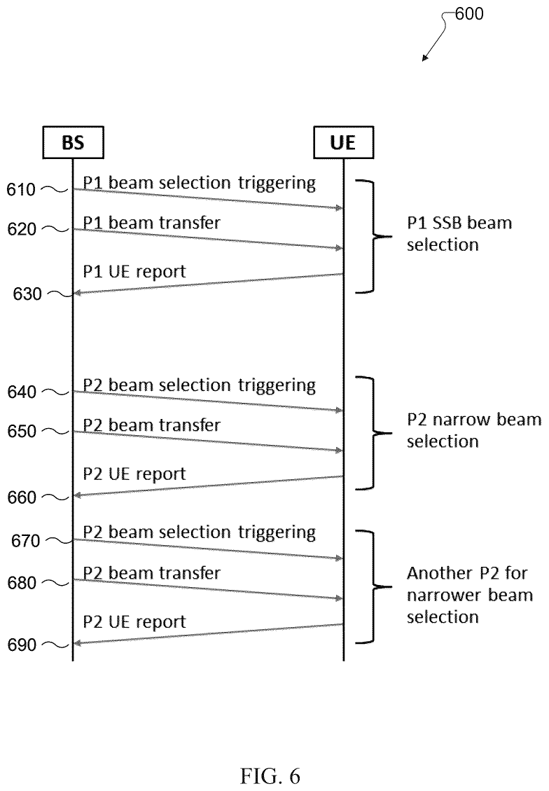

FIG. 6 illustrates a flowchart of an example procedure 600 for beam management according to embodiments of the present disclosure. For example, procedure 600 for beam management can be performed by the UE 116 and the gNB 102 and/or network 130 in the wireless network 100 of FIG. 1. This example is for illustration only and other embodiments can be used without departing from the scope of the present disclosure.

The procedure begins in 610, a BS transmits beam selection triggering to a UE. In 620, the BS transmits beam transfer to the UE. In 630, the UE transmits a UE report to the BS. In 640, the BS transmits beam selection triggering to the UE. In 650, the BS transmits beam transfer to the UE. In 660, the UE transmits a UE report to the BS. In 670, the BS transmits beam selection triggering to the UE. In 680, the BS transmits beam transfer to the UE. In 690, the UE transmits a UE report to the BS.

With reference to FIG. 6, the BS can utilize synchronization signal blocks (SSB) and channel stage information reference signal (CSI-RS) beams for beam managements (BM) as shown. The SSB beam sweeping is named as procedure P1 and the CSI-RS beam sweeping is named as procedure P2 in BM.

For BS with a high number of candidate CSI-RS beams, such as mmWave (analog beams) and extreme massive MIMO (digital or hybrid beams), BS optionally use multiple P2 BM to reduce the overhead and UE BM complexity. For each of the P2, the BS shall transmit the CSI-report triggering and transmit CSI-RS beams on the defined CSI-RS resources. The UE (e.g., the UE 116) once has been triggered, shall measure and report according to the configuration associated to the triggering configuration and triggered CSI-report configuration.

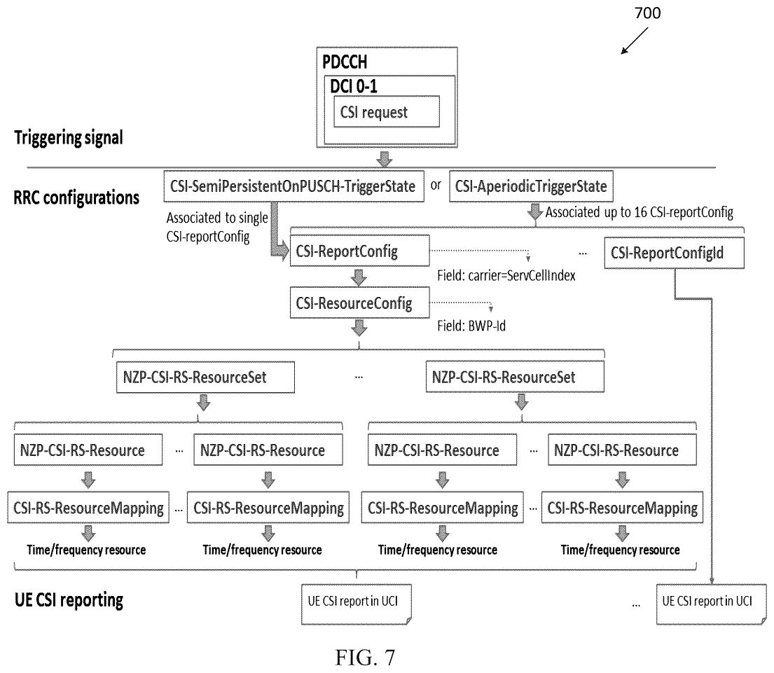

FIG. 7 illustrates a diagram of an example CSI-RS measurement and report configuration 700 according to embodiments of the present disclosure. For example, CSI-RS measurement and report configuration 700 can be implemented by any of the UEs 111-116 of FIG. 1, such as the UE 111. This example is for illustration only and other embodiments can be used without departing from the scope of the present disclosure.

The CSI-RS measurement and report can be triggered by the CSI-RS request carried by downlink control information (DCI) in physical downlink control channel (PDCCH). The report configuration type can be aperiodic or semi-persistent. According to the CSI-RS request, a trigger stage is acquired by the UE. With reference to FIG. 7, according to the format of RRC configuration as shown, the UE can locate multiple CSI-RS resource set with CSI-RS resources, i.e., the time and frequency location of the resource elements (REs), and corresponding parameter configurations to measure the CSI-RS beams and report to the BS.

With reference to FIG. 7, the related RRC elements are briefly introduced herein.

CSI-ResourceConfigId that traced by semi-persistent and aperiodic trigger state lists: The semi-persistent trigger state list is used to configure the UE with list of trigger states for semi-persistent reporting of channel state information on L1. The aperiodic trigger state list is used to configure the UE with a list of aperiodic trigger states. Each codepoint of the DCI field, CSI-RS request, is associated with one aperiodic trigger state, and one or multiple CSI-ReportConfigId:
For semi-persistent trigger state, each trigger stage contains a field of CSI-ReportConfigId that will be used to trace CSI-RS resource mappings by UE.

| -- in 3GPP TR 38.331 [REF1] | |
|---|---|
| CSI-SemiPersistentOnPUSCH-TriggerStateList ::= | SEQUENCE OF CSI- |
| SemiPersistentOnPUSCH-TriggerState | |
| CSI-SemiPersistentOnPUSCH-TriggerState ::= SEQUENCE { | |
| associatedReportConfigInfo | CSI-ReportConfigId, |

...
}

For aperiodic trigger state, each trigger stage contains a sequence, i.e., one or multiple (maximumly 16), of CSI-ReportConfigId that will be used to trace CSI-RS resource mappings by UE.

-- in 3GPP TR 38.331 [REF1]

| | |
|---|---|
| CSI-AperiodicTriggerStateList ::= SEQUENCE OF | CSI-AperiodicTriggerState |

CSI-AperiodicTriggerState ::= SEQUENCE {

| | |
|---|---|
| associatedReportConfigInfoList | SEQUENCE OF CSI- |

AssociatedReportConfigInfo,
...
}
CSI-AssociatedReportConfigInfo ::= SEQUENCE {

| | |
|---|---|
| reportConfigId | CSI-ReportConfigId, |

...
}

CSI-ReportConfig (identified by CSI-ReportConfigId): The CSI-ReportConfig is used to configure a periodic or semi-persistent report. Each CSI-ReportConfig contains a resourcesForChannelMeasurement whose value, CSI-ResourceConfigId, will be used to trace CSI-RS resource mappings by UE. The field carrier in CSI-ReportConfig indicates in which serving cell the CSI-ResourceConfig are to be found.

-- in 3GPP TR 38.331 [REF1]
CSI-ReportConfig ::= SEQUENCE{

| | |
|---|---|
| reportConfigId | CSI-ReportConfigId, |

| | |
|---|---|
| carrier | ServCellIndex |

OPTIONAL,

| | |
|---|---|
| resourcesForChannelMeasurement | CSI-ResourceConfigId, |

...

| | |
|---|---|
| reportConfigType | CHOICE {periodic, semiPersistentOnPUCCH, |

semiPersistentOnPUSCH,

| | |
|---|---|
| | aperiodic}, |
| reportQuantity | CHOICE {none NULL, cri-RI-PMI-CQI NULL, |

cri-RI-i1 NULL,

cri-RI-i1-CQI, cri-RI-CQI NULL, cri-RSRP

NULL,

ssb-Index-RSRP NULL, cri-RI-LI-PMI-

```
CQI NULL},
  ...
  }
```

CSI-ResourceConfig (identified by CSI-ResourceConfigId): The CSI-ResourceConfig defines a group of one or more CSI-RS-ResourceSet, which will be used to trace CSI-RS resource mappings by UE.

-- in 3GPP TR 38.331 [REF1]
CSI-ResourceConfig ::= SEQUENCE{

| | |
|---|---|
| csi-ResourceConfigId | CSI-ResourceConfigId, |

```
  csi-RS-ResourceSetList CHOICE {
    nzp-CSI-RS-SSB SEQUENCE {
```

| | |
|---|---|
| nzp-CSI-RS-ResourceSetList | SEQUENCE OF |
| | NZP-CSI-RS- |

ResourceSetId OPTIONAL,

| | |
|---|---|
| csi-SSB-ResourceSetList | SEQUENCE OF |
| | CSI-SSB-ResourceSetId |

OPTIONAL
},

| | |
|---|---|
| csi-IM-ResourceSetList | SEQUENCE OF |
| | CSI-IM-ResourceSetId |

},

| | |
|---|---|
| bwp-Id | BWP-Id, |

```
  ...
  }
```

NZP-CSI-RS-ResourceSet (identified by NZP-CSI-RS-ResourceSetId): The NZP-CSI-RS-ResourceSet is a set of NZP-CSI-RS resources (their IDs) and set-specific parameters.

-- in 3GPP TR 38.331 [REF1]
NZP-CSI-RS-ResourceSet ::= SEQUENCE{

| | |
|---|---|
| nzp-CSI-ResourceSetId | NZP-CSI-RS-ResourceSetId, |
| nzp-CSI-RS-Resources | SEQUENCE OF NZP-CSI-RS-ResourceId, |

...
}

NZP-CSI-RS-Resource (identified by NZP-CSI-RS-ResourceId): The NZP-CSI-RS-Resource contains one CSI-RS-ResourceMapping, that UE will use to locate the physical resource of the CSI-RS signals for measurement and report.

| -- in 3GPP TR 38.331 [REF1] | |
|---|---|
| NZP-CSI-RS-Resource ::= SEQUENCE{ | |
| nzp-CSI-RS-ResourceId | NZP-CSI-RS-ResourceId, |
| resourceMapping | CSI-RS-ResourceMapping, |

...
}

CSI-RS-ResourceMapping: The CSI-RS-ResourceMapping contains the mapping of a CSI-RS resource in time, frequency, and code domain.

-- in 3GPP TR 38.331 [REF1]
CSI-RS-ResourceMapping ::= SEQUENCE{
frequencyDomainAllocation CHOICE {

```
    row1 BIT STRING (SIZE (4)),
    row2 BIT STRING (SIZE (12)),
    row4 BIT STRING (SIZE (3)),
    other BIT STRING (SIZE (6))
```

},

| | | |
|---|---|---|
| nrofPorts | ENUMERATED | {p1,p2,p4,p8,p12,p16,p24,p32}, |
| firstOFDMSymbol In TimeDomain | INTEGER | (0..13), |
| firstOFDMSymbol In TimeDomain2 | INTEGER | (2..12) OPTIONAL, |
| cdm-Type | ENUMERATED | {noCDM, fd-CDM2, cdm4-FD2- |

TD2, cdm8-FD2-TD4},
density CHOICE {

```
    dot5 ENUMERATED {evenPRBs, oddPRBs},
    one NULL,
    three NULL,
    spare NULL
```

},

| | |
|---|---|
| freqBand | CSI-FrequencyOccupation, |

...
}

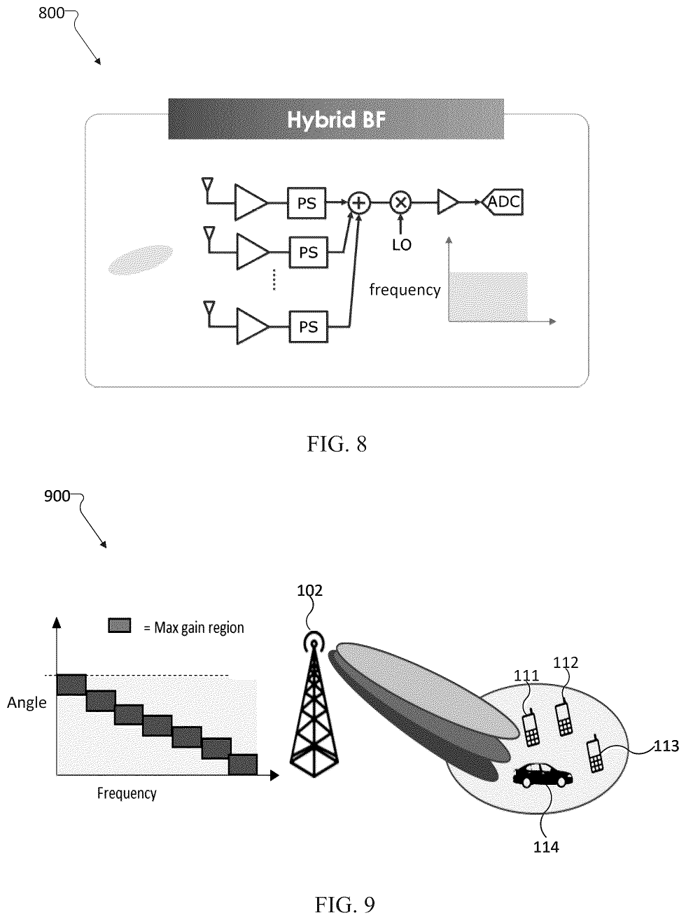

FIG. 8 illustrates an example of a hybrid beamforming structure 800 according to embodiments of the present disclosure. For example, hybrid beamforming structure 800 can be implemented in the BS 103 of FIG. 1. This example is for illustration only and other embodiments can be used without departing from the scope of the present disclosure.

However, other approaches usually use a phase-shifter array or a combination of phase-shifters and switches to connect the large antenna array to a few of RF chains. With reference to FIG. 8, an example of such an architecture is shown.

FIG. 9 illustrates an example of a JPTA beamforming 900 according to embodiments of the present disclosure. For example, JPTA beamforming 900 provides an example of the frequency varying linearly over the system bandwidth and the angular direction sweeping linearly over a certain region according to embodiments of the present disclosure. For example, the JPTA beamforming 900 may be performed in network 130 by BS 102. The JPTA beamforming 900 is for illustration only and other embodiments can be used without departing from the scope of the present disclosure.

For example, with reference to FIG. 8, the case of hybrid beamforming at a base-station (BS) is shown with a single RF chain, i.e., R=1. Note that with M antennas, the maximum beamforming gain in any direction is M. For the BS (e.g., the BS 102) to provide signal coverage to the UEs in the cell, the BS would perform beam sweeping overtime for its frequency-flat beams. With reference to FIG. 9, the typical analog beamforming with beam sweeping is shown.

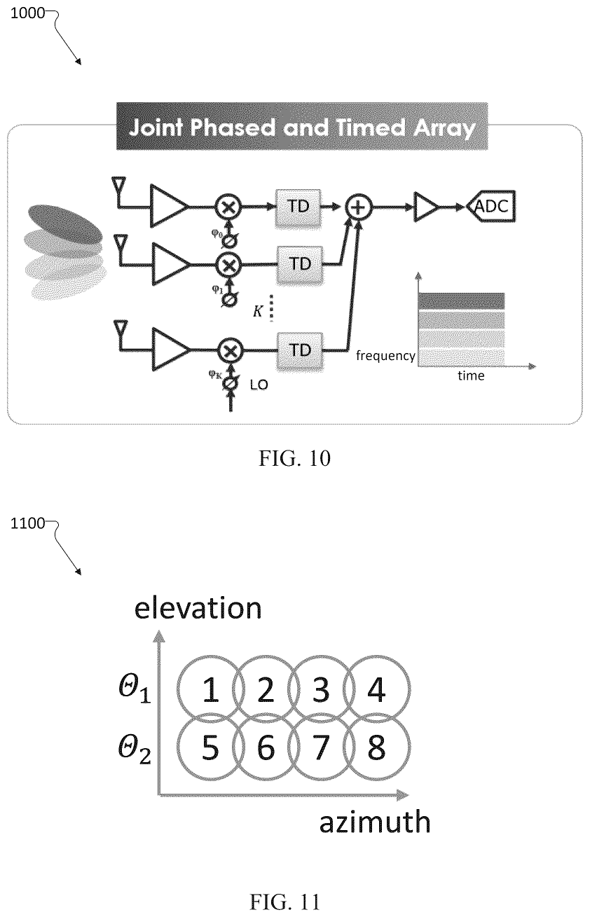

FIG. 10 illustrates an example of a JPTA circuit 1000 according to embodiments of the present disclosure. For example, JPTA circuit 1000 may be implemented in BS 102 and, more particularly, in one or more of the transceivers 210. This example is for illustration only and other embodiments can be used without departing from the scope of the present disclosure.

An alternative to frequency-flat hybrid beamforming is frequency-dependent hybrid beamforming, which is called joint phase-time array (JPTA) beamforming. Note that, here, frequency-dependent beamforming refers to a technique where different components of the input signal may encounter a differently shaped analog beam based on their frequency. To this end, delay elements are utilized in addition to the common phase shifters to create the desired frequency-dependent beam. With reference to FIG. 10, an illustration for JPTA circuit where each antenna is connected through a time delay element (TD) and a phase shifter is shown.

By tuning the delay elements and phase shifters, different frequency-dependent beams can be designed. For example, a rainbow beam (aka continues-angle or prism beam) can be designed. For example, a 2D beam pattern for JPTA rainbow beam, where angles in [−60,60] are associated with a bundle of subcarriers that provides high beam gain. For this design, every azimuth angle is covered by a bundle of subcarriers with a high beam gain. This design is especially useful for beam training or for data multiplying when the cell is highly loaded (many UEs at different angles are associated with the BS). Another interesting design is a 2D beam pattern for JPTA discrete-angle beam, where the angles in {−30, −15, 15, 30] are associated with distinct bundles of subcarriers that provide high beam gain. In this case, the BS designs the JPTA to maximize the beam gain for UEs at different angles over distinct continuous sets of subcarriers. For data transmission, this design is more useful since it can be tailored based on the locations of the UEs and is beneficial even if only two UEs are served by the BS.

In contrast to the phased-array beamforming shown in FIG. 9, UEs at different angles can be served at the same over distinct bundles of sub-carriers without the need for beam sweeping. In the example shown in FIG. 9, UEs at [−30, −15, 15, 30] can be simultaneously served over the corresponding subcarrier (i.e., frequency sub-bands). As a result, every UE has access to the channel, which can be exploited for different purposes including fast beam-training [2], uplink coverage extension [4], and mobility enhancement [6].

To design the beams, different approaches have been provided. For the rainbow beam, a simple solution exists where the delays as set with a constant increment between them [2,5]. Hence, the complexity for designing this kind of beam is very low. For the discrete-angle beam type, different approaches have been provided. In [5], an iterative approach is provided which yields high beam gains, while a simple analytical approach has been provided in [3]. The beam gain for the iterative approach is typically higher than the analytical approach but at the price of high complexity. Regardless of which approach or algorithm is used to design the JPTA beam, the output is in the form of phases and delays that are used to configure the delay elements and the phase shifters in order to achieve the desired beam pattern.

While embodiments of the present disclosure provide on a cellular network where the JPTA beam is designed at the BS side, embodiments of the present disclosure are not limited to this application. The present disclosure could be applied to other systems such as WiFi as well as designing beams at the UE side.

FIG. 11 illustrates a diagram of example angular relationships 1100 for candidate CSI-RS beams according to embodiments of the present disclosure. For example, angular relationships 1100 for candidate CSI-RS beams can be utilized by the BS 102 of FIG. 2. This example is for illustration only and other embodiments can be used without departing from the scope of the present disclosure.

In this example, the BS configures a UE to report the best candidate CSI-RS beam from 8 candidate beams. With reference to FIG. 11, the angular relationship of the 8 beams in BS's perspective is shown. The beams with index 1 to 4 have the same elevation angle Θ₁ but different azimuth angle; the beams with index 5 to 8 have the same elevation angle Θ₂ but different azimuth angle.

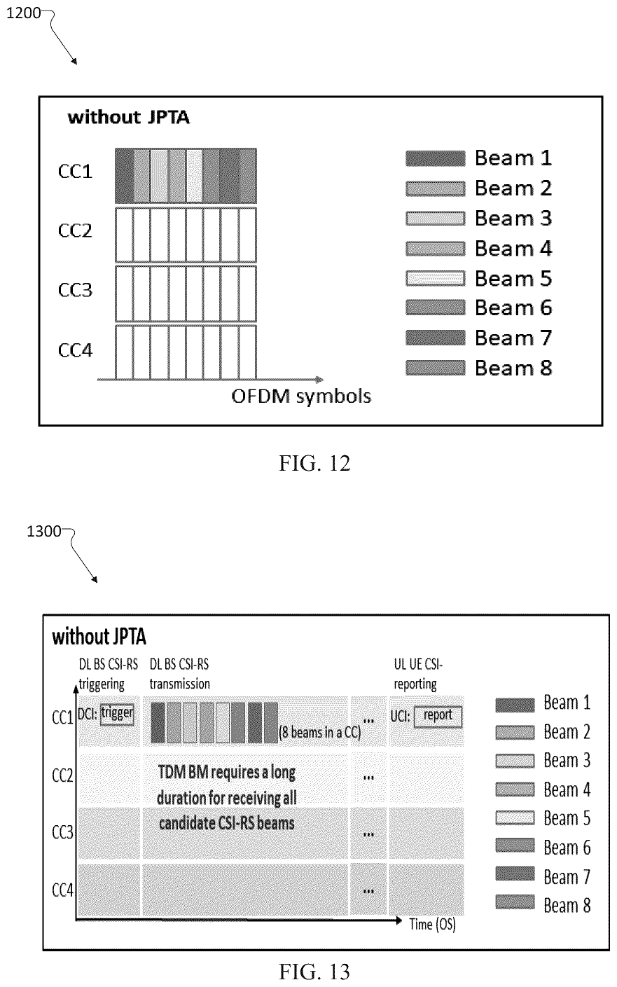

FIG. 12 illustrates a diagram of TDMed CSI-RS beams 1200 according to embodiments of the present disclosure. For example, TDMed CSI-RS beams 1200 can be transmitted by the BS 103 of FIG. 1. This example is for illustration only and other embodiments can be used without departing from the scope of the present disclosure.

With reference to FIG. 12, in ordinary FR2 system (e.g., without JPTA) with fully analog beams or JPTA system with JPTA function is turned off, the 8 candidate CSI-RS beams can be transmitted in time division multiplexing (TDM) manner as shown. Suppose the period of switching the analog beam is one OFDM symbols, 8 OFDM symbols are needed for an 8-to-1 CSI-RS beam selection. Overhead of CSI-RS resources limits the efficiency and time resolution of FR2 beam management.

FIG. 13 illustrates an example of a timeline 1300 for triggering, transmission, and reporting according to embodiments of the present disclosure. For example, timeline 1300 for triggering, transmission, and reporting can be followed by any of the BSs 102-103 of FIG. 1, such as the BS 102, and any of the UEs 111-116 of FIG. 1, such as the UE 116. This example is for illustration only and other embodiments can be used without departing from the scope of the present disclosure.

In terms of CSI-report configuration, one CSI-report is triggered by the BS and the 8 CSI-RS resources are defined in the corresponding CSI-report configuration. With reference to FIG. 13, the timeline of BS to UE CSI-report trigger, CSI-RS resource transmission, and the UE's CSI-report are shown. With reference to FIG. 13, the UE measures the reference signal received power (RSRP) on the 8 informed CSI-RS resources, and reports the selected CSI-RS resource index (CRI) and the RSRP value to the BS. The association among CSI-report, CSI-RS resource, and CSI-RS beams are shown.

CSI-RS beams are transmitted in TDM manner in FR2, e.g., across multiple OFDM symbols. Embodiments of the present disclosure recognize that this incurs relatively large overhead for FR2 beam management. To reduce the overhead of FR2 beam management, jointly utilizing JPTA and carrier aggregation is provided in this disclosure. Multi-beam CSI-RS are transmitted on a same OFDM symbol across different component carriers (CCs) using JPTA frequency-dependent beams. In one example, the CSI-RS beams will be CC-specific for the OFDM symbol configured with CSI-RS.

5G NR specifications does not support the “integrated” report. According to 5G NR, CSI report is configured per cell, and UE (e.g., the UE 116) can be configured to report “combined” reports across the CCs, i.e., the UE will report the RSRPs across the beams in the CCs. Thus,
P2 beam selection cannot be done in one CSI-report.
UE has to transmit multiple CSI-reports for one P2 beam selection, requiring extra UL traffic.
Such limitation requires BS to perform further integration from the reported measurements.

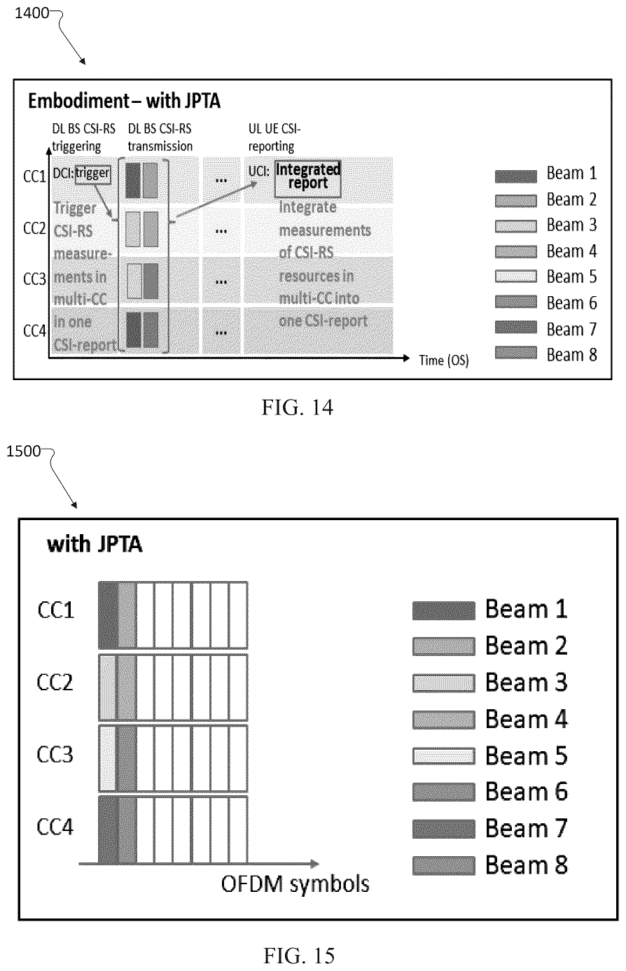

FIG. 14 illustrates an example of a timeline 1400 for triggering, transmission, and reporting according to embodiments of the present disclosure. For example, timeline 1400 for triggering, transmission, and reporting can be followed by any of the BSs 102-103 of FIG. 1, such as the BS 103, and any of the UEs 111-116 of FIG. 1, such as the UE 115. This example is for illustration only and other embodiments can be used without departing from the scope of the present disclosure.

This disclosure provided beam management on JPTA with carrier aggregation. With reference to FIG. 14, the signaling methods are provided to allow “integrated” reports across multiple CCs when CSI-RS is transmitted with multiple JPTA CC-specific beams, as shown. JPTA BS transmits frequency-selective CSI-RS beams in each OFDM symbol mapped with CSI-RS in multiple CCs, e.g., one beam per CC per OFDM symbol. The BS transmits a CSI-report triggering signal to the UE which indicates a transmission of CSI-RS across multiple CCs on a same set of OFDM symbols and triggers CSI-report according to one or multiple CSI-report config. Each CSI-report configuration is associated with multiple CSI-RS resources across multiple CCs. The UE receives and measures CSI-RS across multiple CCs according to the triggering config. The UE generates an integrated CSI-report from multiple CSI-RS measurements across the CCs.

In one method, the integrated CSI-report is constructed with down-selecting information from the multiple measurements, according to certain criteria. In one such example, the integrated CSI-report is constructed by the UE (1) selecting the best or N-best CSI-RS resource with the highest measurement quantities from the multiple measurements across multiple CCs, and (2) constructing information for the report based on the CC & resource index (or -ices) and measurement quantity (or -ies) corresponding to the selected resources.

In one embodiment, beam management using JPTA with carrier aggregation is provided. The BS maps frequency-selective JPTA beams into multiple CCs, e.g., one beam per CC, or one beam across a group of consecutive CCs. For this purpose, the weights for delay elements and phase elements are set such that one JPTA beam is formed per CC (or per group of consecutive CCs). In one example, the entire number of CCs is partitioned into multiple groups of a same consecutive number of CCs; and one JPTA beam is allocated per each group. The beam management overhead is reduced by JPTA together with carrier aggregation.

An embodiment is provided where a BS configures a UE to integrate multiple CSI-RS measurements from multiple CCs into one report. The BS informs the UE which measurements to integrate, e.g., via RRC. The UE reports the N-highest measurements and corresponding resource indices (including the resource indices corresponds to the CC or OFDM symbol indices) from the multiple measurements.
In one method, a BS indicates multiple CSI-RS resources on multiple CCs for a CSI-report configuration. A UE is configured to measure on one or multiple CSI-RS resources across one or multiple CCs indicated by one CSI-report configuration:
   Alternative 1: multiple CSI-report configuration across multiple CCs, 1-1 mapping.
   Alternative 2: single CSI-report configuration across multiple CCs, 1-N mapping.
In one method, a BS indicates multiple CSI report configurations on multiple CCs to be used for a CSI-report. A UE is configured to transmit one CSI-report for each list of CSI-report configuration. The UE integrates multiple CSI-reports in the list to one report after a pre-selection of the information by:
   Selecting the strongest RSRP and report CC index and CSI-RS resource index.
   Selecting the N-strongest RSRPs and report corresponding CCs index and CSI-RS resource index.
In one method, a BS indicates enabling/disabling of CSI-RS measurements integration through a flag. A UE is indicated by the BS to integrate the CSI-RS measurements among the CSI-RS resources associated with the CSI-report configurations in one CSI-report triggering. The indication is through a flag, e.g., in RRC,
   The UE integrates the measurements when UE support the integration, the flag exists, and the flag is configured as enabled.
   Otherwise, the UE may not integrate the measurements.

In one embodiment, a BS configures a UE to integrate multiple CSI-RS measurements from multiple CCs into multiple groups of measurements and to derive one report per group. The BS informs the UE multiple groups of measurements to integrate, e.g., via RRC. The UE reports the N-highest measurements and corresponding resource indices (including the resource indices corresponds to the CC indices) from the multiple measurements in each group.
In one method, a BS indicates multiple grouping configurations of multiple CSI-reports on multiple CCs. A UE is configured to categorize the CSI report configurations into groups. Each group contains CSI-report configurations on one or multiple CCs. For each group, the UE prepares one CSI-report after a pre-selection of the information by:
   Selecting the strongest RSRP and report CC index and CSI-RS resource index.
   Selecting the N-strongest RSRPs and report corresponding CCs index and CSI-RS resource index.

Besides, the embodiments are extendable to digital BS systems:
Implementation issue: Extend one or more embodiments described herein in full-analog system to hybrid and full-digital system. A CSI-report generated by a UE is associated to CSI-RS resources in one or multiple CCs.

FIG. 15 illustrates a diagram of TDMed and FDMed CSI-RS beams 1500 according to embodiments of the present disclosure. For example, TDMed and FDMed CSI-RS beams 1500 can be transmitted by the BS 102 of FIG. 2. This example is for illustration only and other embodiments can be used without departing from the scope of the present disclosure.

In JPTA system, each frequency-selective beam is designed across one or multiple CCs. The beam management overhead is reduced by JPTA and carrier aggregation.

With reference to FIG. 15, in JPTA system with JPTA function is turned on, the 8 candidate CSI-RS beams can be transmitted in frequency division multiplexing (FDM) and TDM manner as shown. For example, frequency-dependent beams per component carrier is formed by JPTA. Suppose the period of switching the analog beam is one OFDM symbol. 2 OFDM symbols are needed for an 8-to-1 CSI-RS beam selection. Overhead of CSI-RS resources limits the efficiency and time resolution of FR2 beam management.

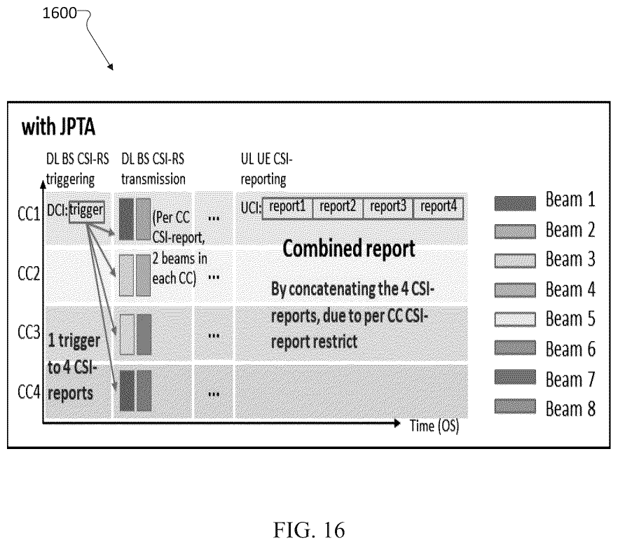

FIG. 16 illustrates an example of a timeline 1600 for triggering, transmission, and reporting according to embodiments of the present disclosure. For example, timeline 1600 for triggering, transmission, and reporting can be followed by any of the BSs 102-103 of FIG. 1, such as the BS 102, and any of the UEs 111-116 of FIG. 1, such as the UE 116. This example is for illustration only and other embodiments can be used without departing from the scope of the present disclosure.

In terms of CSI-report configuration, 4 CSI-report is triggered by the BS and the 8 CSI-RS resources are defined in the corresponding CSI-report configuration. The reason of having 4 CSI-report instead on 1 is due to the per cell per slot limitation of CSI-report, the CSI-report configuration is intra-CC rather than inter-CC. With reference to FIG. 16, the timeline of BS to UE CSI-report trigger, CSI-RS resource transmission, and UE's CSI-report are shown. For each of the CSI-report, the UE measures the RSRP on the 2 informed CSI-RS resources, and reports the selected CSI-RS resource index (CRI) and the RSRP value to the BS. With reference to FIG. 16, the association among CSI-report, CSI-RS resource, and CSI-RS beams are shown.

As a result, the UE reporting overhead is increased with JPTA and per CC CSI-report limitation. Besides, the BS shall receive and combine the 4 CSI-reports to finish the 8-to-1 beam selection. The overhead increase when BS serves an increased number of UEs or high precision beams is scheduled which requires an increased number of candidate beam to be transmitted and multiple stages of the beam selection.

For UE CSI-report format with JPTA, UE transmit 4 CSI-reports in uplink control information (UCI) as shown in Table 1. For example, nrofReportedRS=2 configured by the higher layer configuration, for each CSI-report, the UE reports nrofReportedRS CRI with top nrofReportedRS highest RSRP, as an example of CRI-RSRP is requested. Each CRI has

$$⌈ {log}_{2} ( {K}_{s}^{CSI - RS} ) ⌉ bits ,$$

in which

$${K}_{s}^{CSI - RS}$$

is the number of CSI-RS resources in the corresponding resource set. In Table 1, CRIs are named as “CRI-a-b”, where “a” in the report index and “b” is the CRI index in the report in range [1, nrofReportedRS]. Besides, the RSRP values are included in the CSI-report. The highest RSRP is quantized to a 7-bit value in the range [−140, −44] dBm with 1 dB step size, and the rest of RSRP values are differential RSRP, which are quantized to a 4-bit value. In Table 1, RSRPs are named as “RSRP-a-b”, where “a” in the report index and “b” is the CRI index in the report in range [1, nrofReportedRS].

TABLE 1

| CSI-report # | Field | Bitwidth |
|---|---|---|
| CSI-RS | CRI-1-1 | $⌈ {log}_{2} ( {K}_{s}^{CSI - RS} ) ⌉$ |
| report 1 | CRI-1-2 | $⌈ {log}_{2} ( {K}_{s}^{CSI - RS} ) ⌉$ |
| | RSRP-1-1 | 7 bits |
| | RSRP-1-2 | 4 bits |
| CSI-RS | CRI-2-1 | $⌈ {log}_{2} ( {K}_{s}^{CSI - RS} ) ⌉$ |
| report 2 | CRI-2-2 | $⌈ {log}_{2} ( {K}_{s}^{CSI - RS} ) ⌉$ |
| | RSRP-2-1 | 7 bits |
| | RSRP-2-2 | 4 bits |
| CSI-RS | CRI-3-1 | $⌈ {log}_{2} ( {K}_{s}^{CSI - RS} ) ⌉$ |
| report 3 | CRI-3-2 | $⌈ {log}_{2} ( {K}_{s}^{CSI - RS} ) ⌉$ |
| | RSRP-3-1 | 7 bits |
| | RSRP-3-2 | 4 bits |
| CSI-RS | CRI-4-1 | $⌈ {log}_{2} ( {K}_{s}^{CSI - RS} ) ⌉$ |
| report 4 | CRI-4-2 | $⌈ {log}_{2} ( {K}_{s}^{CSI - RS} ) ⌉$ |
| | RSRP-4-1 | 7 bits |
| | RSRP-4-2 | 4 bits |

In another embodiment, a BS configures a UE to integrate multiple CSI-RS measurements from multiple CCs into one report. The BS informs the UE which measurements to integrate, e.g., via RRC. The UE reports the N-highest measurements and corresponding resource indices (including the resource indices corresponds to the CC indices) from the multiple measurements.

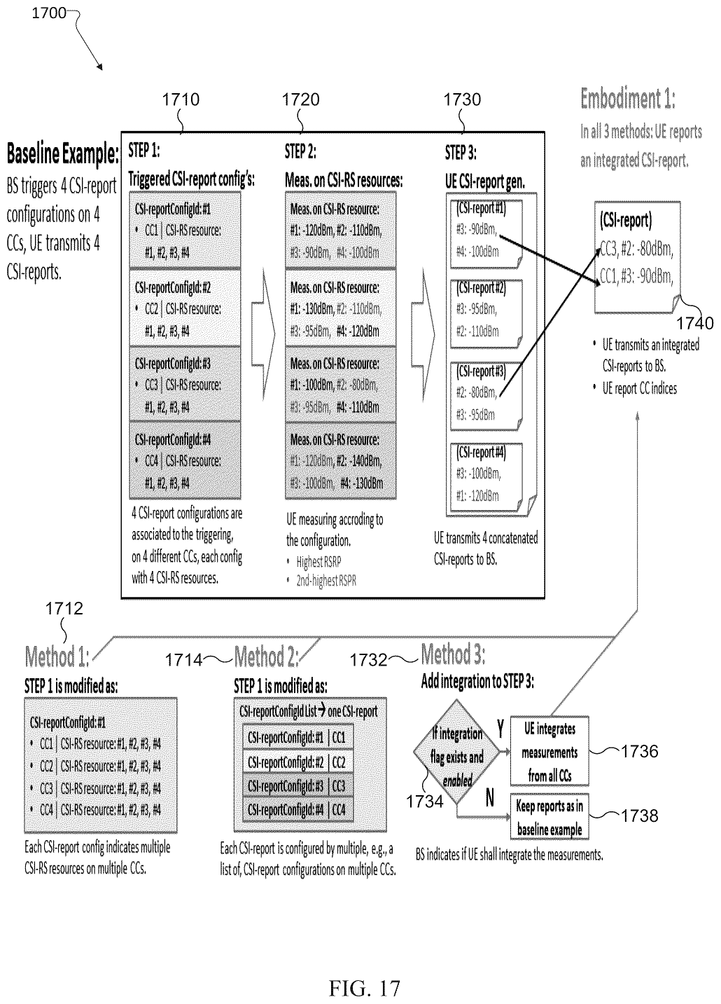

FIG. 17 illustrates a flow diagram for an example UE procedure 1700 for transmitting an integrated CSI report according to embodiments of the present disclosure. For example, UE procedure 1700 for transmitting an integrated CSI report can be performed by any of the UEs 111-116 of FIG. 1, such as the UE 116 of FIG. 3, and a complementary process may be performed by a BS, such as the BS 102 of FIG. 2. This example is for illustration only and other embodiments can be used without departing from the scope of the present disclosure.

The procedure begins in 1710, a UE is triggered four CSI report configurations on four different CCs. The four CSI report configurations are associated to the triggering on the four different CCs. Each CSI report configuration comes with four CSI-RS resources. In 1720, the UE measures according to the configuration on CSI-RS resources. For example, the UE could measure the highest RSRP or the second highest RSRP. In 1730, the UE generates the four concatenated CSI reports and transmits the four concatenated CSI report to the BS.

As an modification to 1710, in 1712, a UE is triggered four CSI report configurations where each CSI report configuration indicates multiple CSI-RS resources on multiple CCs. As an additional modification to 1710, in 1714, a UE is triggered four CSI report configurations where each CSI report is configured by multiple, e.g., a list of, CSI report configurations on multiple CCs.

Additionally to 1730, in 1732, the BS indicates to the UE whether the UE shall integrate the measurements. In 1734, the UE determines whether an integration flag exists and is enabled. If an integration flag exists and is enabled, then in 1736, the UE integrates measurements from all CCs. If an integration flag does not exist or is not enabled, then in 1738, the UE keeps the CSI reports as in the baseline example described herein. After 1712, 1714, and/or 1732, in 1740, the UE transmits an integrated CSI report to the BS. The UE also reports CC indices.

With reference to FIG. 17, a high-level example of one or more embodiments described herein is shown. In a baseline example, 4 CSI-report are triggered. Each CSI-report is configured on a dedicated component carrier with 4 CSI-RS resources. With reference to FIG. 17, the set of CSI-RS resources in each CSI-report configuration can be the same or different. In the baseline, the UE measures, e.g., RSRP, one each of the CSI-RS resources of each of component carrier associated to each CSI-report configuration. For each CSI-report configuration, the UE selects top-N, e.g., N=2, measurements from the CSI-RS resources in that CSI-report configuration. In the baseline example, the UE generates and transmits 4 CSI-reports to the BS. In one or more embodiments described herein, instead of transmitting 4 CSI-reports, the UE transmits an integrated CSI-RS report in this example. With reference to FIG. 17, the integrated CSI-report selects CSI-RS measurement from the CSI-RS resources in the CSI-report configurations as shown.

The methods achieving one or more embodiments described herein are introduced as follows. One or more embodiments described herein are capable of configuring a UE to integrate the CSI-RS measurements on multiple component carriers in one CSI-report. Besides, one or more methods described herein are also capable to integrate the CSI-RS measurements on multiple component carriers in multiple CSI-reports.

In one method, configuring multiple CSI-RS resources across multiple CCs is provided.

In this method, a BS configures one or multiple CSI-RS resource configuration(s) and one or multiple component carrier(s) in one CSI-report configuration. The number of CSI-RS resources configuration(s) is the same to the number of component carrier(s) in one CSI-report configuration. Each CSI-report is associate to one or more CSI-RS resource configuration(s) which has their own component carriers. The component carrier(s) can be the same or different. For each CSI-report, the UE captures top-N CSI-RS resources from the CSI-RS resource configuration in the CSI-report configuration based on measurements, where the N is a higher layer configured parameter, e.g., nrofReportedRS, or configured in the CSI-report configuration.

For example, in the scenario when a CSI-report is needed to across multiple component carrier according to the BS application, for example in JPTA BS, the CSI-reports are configured with different component carriers. The BS can utilize one or more methods described herein to trigger one more multiple CSI-report list(s) each list is across a number of component carriers.

The alternatives and examples herein are illustrated using aperiodic CSI-report. However, one or more methods described herein are not limited to aperiodic CSI-report. One or more methods described herein can also be applied to periodic CSI-report, semi-persistent CSI-reports, etc. One or more methods described herein are not limited to CSI-RS beam selection, but also for the other CSI-report related functions, e.g., interference measurements, etc.

With reference to FIG. 15, to illustrate the following alternative and examples in this method, the example of transmitted 8 CSI-RS beams with JPTA BS is used as shown.
In another alternative, a BS configures a list of CSI-RS resource configuration and a list of component carrier in one CSI-report configuration. Each list of CSI-RS resource contains one or multiple CSI-RS resource configurations. Each list of component carrier contains one or multiple component carriers. The number of elements is the same in the list of CSI-RS resources configuration or the list of component carriers.
   In an example, a BS configures a list of CSI-RS resource configuration and a list of component carrier in one CSI-report configuration. Each list of CSI-RS resource contains one or multiple CSI-RS resource configurations. Each list of component carrier contains one or multiple component carriers. The number of elements is the same in the list of CSI-RS resources configuration or the list of component carriers. For each CSI-report, the UE transmits an integrated CSI-report which captures top-N CSI-RS resources according to the measurements. The N is a higher layer configured parameter, e.g., nrofReportedRS.

-- in 3GPP TR 38.331 [REF1]
CSI-ReportConfig ::= SEQUENCE{

| | |
|---|---|
| reportConfigId | CSI-ReportConfigId, |
| carrier | SEQUENC of ServCellIndex |

OPTIONAL,

| | |
|---|---|
| resourcesForChannelMeasurement | SEQUENC of |
| | CSI-ResourceConfigId, |

...
}

In an example, a BS configures a list of CSI-RS resource configuration and a list of component carrier in one CSI-report configuration. Each list of CSI-RS resource contains one or multiple CSI-RS resource configurations. Each list of component carrier contains one or multiple component carriers. The number of elements is the same in the list of CSI-RS resources configuration or the list of component carriers. For each CSI-report, a UE transmits an integrated CSI-report which captures top-N CSI-RS resources according to the measurements. The N is a higher layer configured parameter, e.g., nrofReportedRS, or configured with such list, according to one or more examples described herein, if exists. In one example, such field, nrofReportedRS, is optional. A UE uses such field when it exists. Otherwise, use higher layer configured value, e.g., nrofReportedRS. In another example, such field, nrofReportedRS, is mandatorily provided by the BS (e.g., the BS 102) to the UE, and the UE will not use higher layer configured value, e.g., nrofReportedRS.

-- in 3GPP TR 38.331 [REF1]
CSI-ReportConfig ::= SEQUENCE{

| | |
|---|---|
| reportConfigId | CSI-ReportConfigId, |
| carrier | SEQUENC of ServCellIndex |

OPTIONAL,

| | |
|---|---|
| resourcesForChannelMeasurement | SEQUENC of |
| | CSI-ResourceConfigId, |
| nrofReportedRS | ENUMERATED {n1, n2, n3, |
| | n4} |

OPTIONAL,
...
}

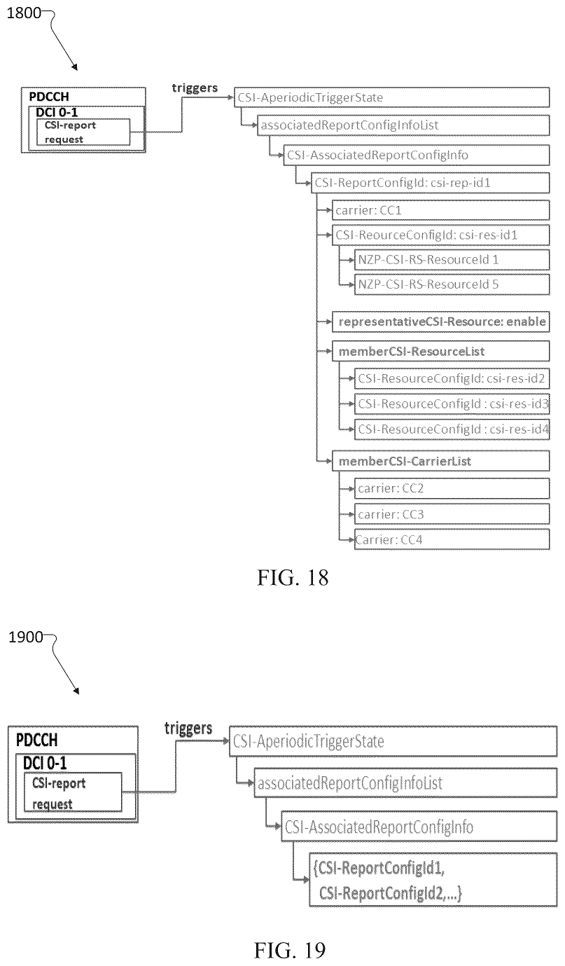

FIG. 18 illustrates a diagram of an example trigger configuration 1800 according to embodiments of the present disclosure. For example, trigger configuration 1800 can be configured by the BS 102 of FIG. 1. This example is for illustration only and other embodiments can be used without departing from the scope of the present disclosure.
In an alternative, the CSI-ResourceConfig informed in the CSI-ReportConfig can performs as a representative CSI-RS resource configuration. The CSI-ResourceConfig is on the carrier informed in the CSI-ReportConfig. The additional one or more CSI-ResourceConfig(s) and their carrier(s) are informed in the same CSI-ReportConfig. The UE configured by a CSI-ReportConfig will measure from the CSI-RS resources informed by both representative CSI-ResourceConfig and member CSI-ResourceConfig(s) on their own carrier informed in the same CSI-ReportConfig. Then the UE generates one CSI-report for the CSI-ReportConfig.
   With reference to FIG. 18, in an example, a new field to inform a certain CSI-ReportConfig is a representative CSI-RS resource configuration, e.g., using representativeCSI-Resource as shown. When representativeCSI-Resource exists and configured as enabled, the UE will obtain the member CSI-RS resource and carrier configurations from two lists in the same CSI-ReportConfig, e.g., memberCSI-ResourceList and memberCSI-CarrierList, which contain the extra one or more CSI-ResourceConfigId(s) and carrier(s). In an example, a UE reports the capability of extra CSI-RS resources configuration and carriers to the BS, e.g., csi-representative-resource-config. If csi-representative-resource-config exists and reported as supported by the UE, the UE supports the extra CSI-RS resources configuration and carriers in the CSI-report configuration; otherwise, the UE may not support.

-- in 3GPP TR 38.331 [REF1]
CSI-ReportConfig ::= SEQUENCE{

| | |
|---|---|
| reportConfigId | CSI-ReportConfigId, |

| | |
|---|---|
| carrier | ServCellIndex |

OPTIONAL,

| | |
|---|---|
| resourcesForChannelMeasurement | CSI-ResourceConfigId, |

...

| | |
|---|---|
| representativeCSI-Report | EUMERATED {enabled, disabled}, |

OPTIONAL,

| | | |
|---|---|---|
| memberCSI-ResourceList | SEQUENCE of | CSI-ResourceConfigId |

OPTIONAL,

| | | |
|---|---|---|
| memberCSI-CarrierList | SEQUENCE of | ServCellIndex |

```
OPTIONAL,
  ...
}
Phy-ParametersFRX-Diff ::= SEQUENCE {
    ...
```

| | |
|---|---|
| csi-representative-resource-config | ENUMERATED {supported}, |

```
    OPTIONAL,
    ...
}
```

With reference to FIG. 18, in another example, a new field to inform a certain CSI-ReportConfig is a representative CSI-RS resource configuration, e.g., using representativeCSI-Resource as shown. When representativeCSI-Resource exists and configured as enabled, the UE will obtain the member CSI-RS resource and carrier configurations from one list in the same CSI-ReportConfig, e.g., memberCSI-ResourceList, which contain the extra one or more CSI-ResourceConfigId(s) and carrier(s). In an example, a UE reports the capability of extra CSI-RS resources configuration and carriers to the BS, e.g., csi-representative-resource-config. If csi-representative-resource-config exists and reported as supported by the UE, the UE supports the extra CSI-RS resources configuration and carriers in the CSI-report configuration; otherwise, the UE may not support.

-- in 3GPP TR 38.331 [REF1]
CSI-ReportConfig ::= SEQUENCE{

| | |
|---|---|
| reportConfigId | CSI-ReportConfigId, |
| carrier | ServCellIndex |

OPTIONAL,

| | |
|---|---|
| resourcesForChannelMeasurement | CSI-ResourceConfigId, |

...

| | |
|---|---|
| representativeCSI-Report | EUMERATED {enabled, |
| | disabled}, |

OPTIONAL,

| | |
|---|---|
| memberCSI-ResourceList | SEQUENCE{ |
| SEQUENCE of | CSI-ResourceConfigId, |
| SEQUENCE of | ServCellIndex, |
| }, | OPTIONAL |

```
  ...
}
Phy-ParametersFRX-Diff ::= SEQUENCE {
    ...
```

| | |
|---|---|
| csi-representative-resource-config | ENUMERATED |
| | {supported}, |

```
    OPTIONAL,
    ...
}
```

In one alternative, the BS aligns the configuration of each CSI-report and/or resource configuration included in each list. The UE obtains the CSI-report and/or resource configuration from any of the CSI-report and/or resource configuration within the list.
In another alternative, the BS allows the CSI-report and/or resource configurations in each list are conflicted. The UE (e.g., the UE 116) shall obtain the CSI-report and/or resources configuration from the first CSI-report and/or resource configuration within the list.
In another alternative, the BS allows the CSI-report and/or resource configurations in each list are conflicted. The UE shall obtain the CSI-report and/or resources configuration from the explicitly indicated CSI-report and/or resource configuration within the list.
   In an example, the BS informs the UE the index of the CSI-report and/or resource configuration via higher layer RRC signaling/parameter and/or MAC CE command and/or dynamic DCI based signaling.
      In one example, the BS informs the UE a certain CSI-report and/or resource configuration ID.
      In another example, the BS informs an index of a CSI-report and/or resource configuration, e.g., the k-th element, in the list.
   In another example, the BS informs the UE the index of the CSI-report and/or resource configuration within the CSI-report configuration.
      In one example, the BS informs the UE a certain CSI-report and/or resource configuration ID.
      In another example, the BS informs an index of a CSI-report and/or resource configuration, e.g., the k-th element, in the list.
In one alternative (referred as BM-md1-a), a UE reports top-N measurement(s) with their CSI-RS resource indices and their indices of the CSI-report in the group, and reports the top-N overall CSI-RS resource index together with the measurements.
   In an example shown in Table 2, nrofReportedRS=2 configured by the higher layer configuration, for each CSI-report. Additional index, e.g., “CC-X-b” are included in the CSI-report, where “X” in the index of the CSI-report configuration according to one or more methods described herein, or the index of the representative and member CSI-ReportConfig(s) or CSI-ResourceConfig(s) according to one or more methods described herein; and “b” is the CRI index in the report in range [1, nrofReportedRS]. Such component carrier index required

$$⌈ {log}_{2} ( {K}^{CSI - CC} ) ⌉ bits ,$$

where K^{CSI-CC} is the number of CSI-report to be combined in one or more methods described herein or the number of representative and member CSI-ReportConfig(s) or CSI-ResourceConfig(s) in one or more methods described herein. CRIs are named as “CRI-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS]. CRI contains

$$⌈ {log}_{2} ( {K}_{X}^{CSI - RS} ) ⌉ bits ,$$

in which

$${K}_{X}^{CSI - RS} ,$$

In an example,

$${K}_{X}^{CSI - RS}$$

is the is the number of CSI-RS resources in the corresponding CSI-report configuration in one or more methods described herein or the number of the CSI-RS resources in the representative and member CSI-ReportConfig(s) or CSI-ResourceConfig(s) according to one or more methods described herein.
In another example,

$${K}_{X}^{CSI - RS}$$

is the maximum of the number of CSI-RS resources in the corresponding CSI-report configuration in one or more methods described herein or the number of the CSI-RS resources in the representative and member CSI-ReportConfig(s) or CSI-ResourceConfig(s) according to one or more methods described herein.

In Table 2, RSRPs are named as “RSRP-X-b”, where “X” in the index of the CSI-report configuration in one or more methods described herein or the index of the representative and member CSI-ReportConfig or CSI-ResourceConfig in this method; and “b” is the CRI index in the report in range [1, nrofReportedRS].

TABLE 2

| CSI-report # | Field | Bitwidth |
|---|---|---|
| CSI-report | CC-X-1 | $⌈ {log}_{2} ( {K}_{s}^{CSI - CC} ) ⌉$ |
| | CC-X-2 | $⌈ {log}_{2} ( {K}_{s}^{CSI - CC} ) ⌉$ |
| | CRI-X-1 | $⌈ {log}_{2} ( {K}_{X}^{CSI - RS} ) ⌉$ |
| CSI-RS | CRI-X-2 | $⌈ {log}_{2} ( {K}_{X}^{CSI - RS} ) ⌉$ |
| | RSRP-X-1 | 7 bits |
| | RSRP-X-2 | 4 bits |

In another example, the component carrier index in Table 2 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative (referred as BM-md1-b), a UE indexes the CSI-RS resource index among the CSI-report configurations. The UE reports the top-N measurements and their overall CSI-RS resource indices.
In an example shown in Table 3, nrofReportedRS=2 configured by the higher layer configuration, for each CSI-report. CRIs are named as “CRI-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS]. CRI contains

$$⌈ {log}_{2} ( {K}_{r}^{CSI - RS} ) ⌉ bits ,$$

in which

$${K}_{r}^{CSI - RS}$$

is the number of CSI-RS resources in the corresponding CSI-report configuration. In Table 3, RSRPs are named as “RSRP-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS].

TABLE 3

| CSI-report # | Field | Bitwidth |
|---|---|---|
| CSI-report | CRI-X-1 | $⌈ {log}_{2} ( {K}_{r}^{CSI - RS} ) ⌉$ |
| | CRI-X-2 | $⌈ {log}_{2} ( {K}_{r}^{CSI - RS} ) ⌉$ |
| | RSRP-X-1 | 7 bits |
| | RSRP-X-2 | 4 bits |

In another example, the component carrier index in Table 3 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative, the BS configures a UE with which bit-format the UE shall use.
In an example, a BS informs a UE the format of the CSI-report through a field in the triggering configuration.
   In an example, a field, e.g., csi-report-format, is added to CSI-AperiodicTriggerState informing the format of the CSI-report group in the list. The csi-report-format can be configured as reportIndex-CRI. The UE reports the group using BM-md1-a; if the csi-report-format is configured as combined-CRI, the UE reports the group using BM-md1-b.

-- in 3GPP TR 38.331 [REF1]
CSI-AperiodicTriggerState ::= SEQUENCE {
...

| | |
|---|---|
| csi-report-format | ENUMERATED {reportIndex-CRI, combined- |

CRI, } OPTIONAL,
...
}

In an example, a BS informs a UE the format of the CSI-report through a field in the CSI-report configuration.
   In an example, a field, e.g., csi-report-format, is added to CSI-ReportConfig informing the format of a CSI-report. The csi-report-format can be configured as reportIndex-CRI. The UE reports the group using BM-md1-a; if the csi-report-format is configured as combined-CRI, the UE reports the group using BM-md1-b.

-- in 3GPP TR 38.331 [REF1]
CSI-ReportConfig ::= SEQUENCE{
...

| | |
|---|---|
| csi-report-format | ENUMERATED |
| | {reportIndex-CRI, |

```
combined-CRI, } OPTIONAL,
  ...
}
Phy-ParametersFRX-Diff ::= SEQUENCE {
  ...
```

| | |
|---|---|
| csi-representative-resource-config | ENUMERATED {supported}, |

OPTIONAL,
...
}

In another method, a BS indicates multiple CSI report configurations on multiple CCs to be used for a CSI-report.

In this method, a BS configures a list of CSI-report configuration as one CSI-report. Such list contains one or multiple CSI-report configurations that are able to associate to more than one component carrier in the control signaling from the BS to the UE. For each list, the UE transmits an integrated CSI-report which captures top-N CSI-RS resources based on measurements among the CSI-report configuration in the list. The N is a higher layer configured parameter, e.g., nrofReportedRS, or configured with such list.

For example, in the scenario when a CSI-report is needed to across multiple component carrier according to the BS application, for example in JPTA BS, the CSI-reports are configured with different component carriers. The BS can utilize one or more methods described herein to trigger one more multiple CSI-report list(s) each list is across a number of component carriers.

The alternatives and examples herein are illustrated using aperiodic CSI-report. However, one or more methods described herein are not limited to aperiodic CSI-report. One or more methods described herein can also be applied to periodic CSI-report, semi-persistent CSI-reports, etc. One or more methods described herein are not limited to CSI-RS beam selection, but also for the other CSI-report related functions, e.g., interference measurements, etc.

With reference to FIG. 15, to illustrate the following alternative and examples in this method, the example of transmitted 8 CSI-RS beams with JPTA BS is used as shown.

FIG. 19 illustrates a diagram of an example trigger configuration 1900 according to embodiments of the present disclosure. For example, trigger configuration 1900 can be configured by the BS 103 of FIG. 1. This example is for illustration only and other embodiments can be used without departing from the scope of the present disclosure.
In one alternative, the BS configures a UE one or multiple list of CSI-report configuration. The UE transmits one CSI-report for each list of CSI-report configuration. For each list, the UE transmits an integrated CSI-report which captures top-N CSI-RS resources according to the measurements. The N is a higher layer configured parameter, e.g., nrofReportedRS, or configured with such list.
   With reference to FIG. 19 (and according to one or more figures described herein), in an example, the BS (e.g., the BS 102) configures UE one or multiple list of CSI-report configuration in control signaling, e.g., CSI-AssociatedReportConfigInfo as shown. The UE transmits one CSI-report for each list of CSI-report configuration. For each list, the UE transmits an integrated CSI-report which captures top-N CSI-RS resources according to the measurements. The N is a higher layer configured parameter, e.g., nrofReportedRS.

-- in 3GPP TR 38.331 [REF1]

| | |
|---|---|
| CSI-AperiodicTriggerStateList ::= SEQUENCE OF | CSI-AperiodicTriggerState |

CSI-AperiodicTriggerState ::= SEQUENCE {

| | |
|---|---|
| associatedReportConfigInfoList | SEQUENCE OF CSI- |

AssociatedReportConfigInfo,
...
}
CSI-AssociatedReportConfigInfo ::= SEQUENCE {

| | |
|---|---|
| reportConfigId | SEQUENCE OF CSI- |

ReportConfigId,
...
}

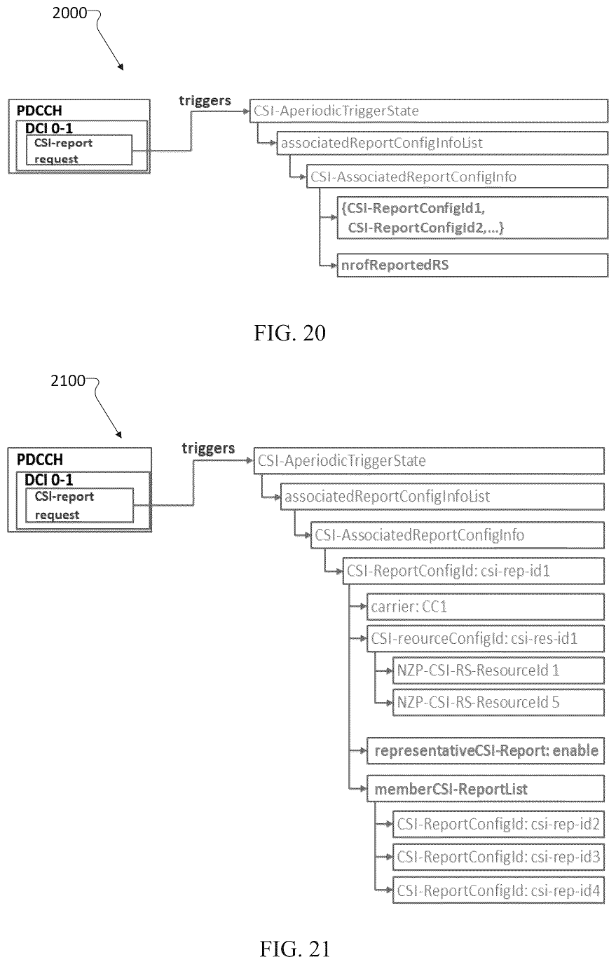

FIG. 20 illustrates a diagram of an example trigger configuration 2000 according to embodiments of the present disclosure. For example, trigger configuration 2000 can be configured by the BS 102 of FIG. 1. This example is for illustration only and other embodiments can be used without departing from the scope of the present disclosure.
With reference to FIG. 20 (and according to one or more figures described herein), in another example, the BS configures a UE one or multiple list of CSI-report configuration in control signaling, e.g., CSI-AssociatedReportConfigInfo as shown. The UE transmits one CSI-report for each list of CSI-report configuration. For each list, the UE transmits an integrated CSI-report which captures top-N CSI-RS resources according to the measurements. The N is a higher layer configured parameter, e.g., nrofReportedRS, or configured with such list, according to one or more examples described herein, if exists. In one example, such field, nrofReportedRS, is optional. A UE uses such field when it exists. Otherwise, use higher layer configured value, e.g., nrofReportedRS. In another example, such field, nrofReportedRS, is mandatorily provided by the BS to the UE, and the UE will not use higher layer configured value, e.g., nrofReportedRS.

-- in 3GPP TR 38.331 [REF1]

| | |
|---|---|
| CSI-AperiodicTriggerStateList ::= SEQUENCE OF | CSI-AperiodicTriggerState |

CSI-AperiodicTriggerState ::= SEQUENCE {

| | |
|---|---|
| associatedReportConfigInfoList | SEQUENCE OF CSI- |

AssociatedReportConfigInfo,
...
}
CSI-AssociatedReportConfigInfo ::= SEQUENCE {

| | |
|---|---|
| reportConfigId | SEQUENCE OF CSI- |

ReportConfigId,

| | |
|---|---|
| nrofReportedRS | ENUMERATED {n1, n2, n3, n4} |

OPTIONAL,
...
}

FIG. 21 illustrates a diagram of an example trigger configuration 2100 according to embodiments of the present disclosure. For example, trigger configuration 2100 can be configured by the BS 103 of FIG. 1. This example is for illustration only and other embodiments can be used without departing from the scope of the present disclosure.
In one alternative, the CSI-ReportConfig can performs as a representative CSI-report configuration and informs additional CSI-report configurations as member CSI-report configurations. The UE is configured by the representative CSI-ReportConfig. The UE will measure from the CSI-RS resources informed by both representative CSI-ReportConfig and member CSI-ReportConfig(s), as the CSI-RS resources are from one CSI-ReportConfig. Then the UE generates one CSI-report for the representative CSI-ReportConfig.
   With reference to FIG. 21, in an example, a new field to inform a certain CSI-ReportConfig is a representative CSI-report configuration, e.g., using representativeCSI-Report as shown. When representativeCSI-Report exists and configured as enabled, the UE will obtain the member CSI-report configurations from the same CSI-ReportConfig, e.g., memberCSI-ReportList, which contains the extra one or more CSI-ReportConfigId(s). The member CSI-ReportConfig can include the same or different carrier index from the representative CSI-ReportConfig. In an example, a UE reports the capability of extra CSI-RS resources configuration and carriers to the BS, e.g., csi-representative-report-config. If csi-representative-report-config exists and reported as supported by the UE, the UE supports the extra CSI-report configuration and carriers in the CSI-report configuration; otherwise, the UE may not support. For each CSI-report, the UE transmits an integrated CSI-report which captures top-N CSI-RS resources according to the measurements. The N is a higher layer configured parameter, e.g., nrofReportedRS.

-- in 3GPP TR 38.331 [REF1]
CSI-ReportConfig ::= SEQUENCE{

| | |
|---|---|
| reportConfigId | CSI-ReportConfigId, |

| | |
|---|---|
| carrier | ServCellIndex |

OPTIONAL,

| | |
|---|---|
| resourcesForChannelMeasurement | CSI-ResourceConfigId, |

...

| | |
|---|---|
| representativeCSI-Report | EUMERATED {enabled, disabled}, |

OPTIONAL,

| | | |
|---|---|---|
| memberCSI-ReportList | SEQUENCE of | CSI-ReportConfigId |

```
OPTIONAL,
  ...
}
Phy-ParametersFRX-Diff ::= SEQUENCE {
  ...
```

| | |
|---|---|
| csi-representative-report-config | ENUMERATED {supported}, |

OPTIONAL,
...
}

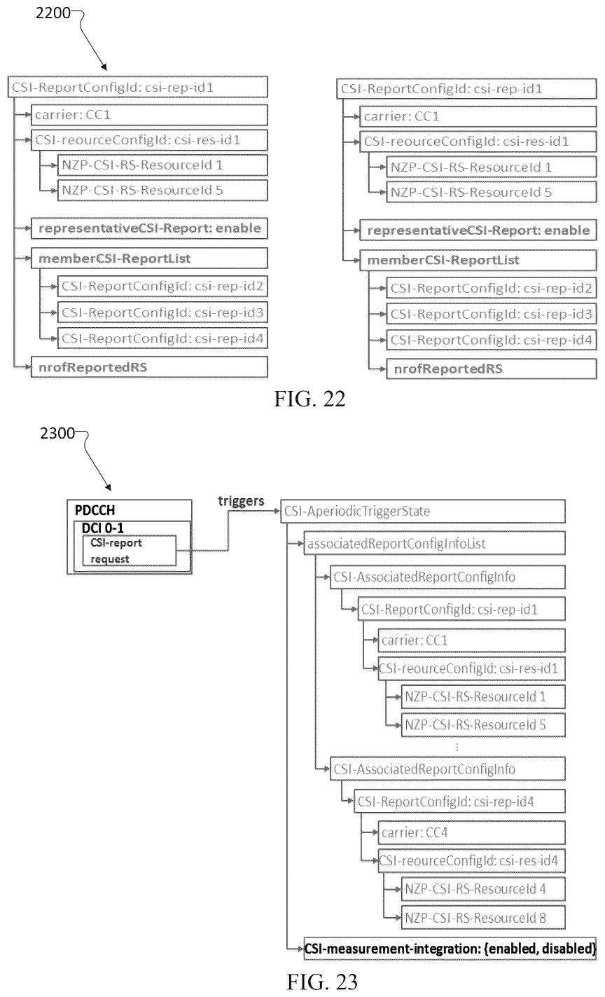

FIG. 22 illustrates a diagram of example CSI report configurations 2200 according to embodiments of the present disclosure. For example, CSI report configurations 2200 can be implemented by any of the UEs 111-116 of FIG. 1, such as the UE 112. This example is for illustration only and other embodiments can be used without departing from the scope of the present disclosure.
With reference to FIG. 22, in another example, a new field to inform a certain CSI-ReportConfig is a representative CSI-report configuration, e.g., using representativeCSI-Report as the two examples shown. When representativeCSI-Report exists and configured as enabled, the UE will obtain the member CSI-report configurations from the same CSI-ReportConfig, e.g., memberCSI-ReportList which contains the extra one or more CSI-ReportConfigId(s). The member CSI-ReportConfig can include the same or different carrier index from the representative CSI-ReportConfig. In an example, UE (e.g., the UE 116) reports the capability of extra CSI-RS resources configuration and carriers to the BS, e.g., csi-representative-report-config. If csi-representative-report-config exists and reported as supported by the UE, the UE supports the extra CSI-report configuration and carriers in the CSI-report configuration; otherwise, the UE may not support. For each CSI-report, the UE transmits an integrated CSI-report which captures top-N CSI-RS resources according to the measurements. The N is a higher layer configured parameter, e.g., nrofReportedRS, or configured with such list, according to one or more examples described herein, if exists. In one example, such field, nrofReportedRS, is optional. A UE uses such field when it exists. Otherwise, use higher layer configured value, e.g., nrofReportedRS. In another example, such field, nrofReportedRS, is mandatorily provided by the BS to the UE, and the UE will not use higher layer configured value, e.g., nrofReportedRS.

-- in 3GPP TR 38.331 [REF1]
CSI-ReportConfig ::= SEQUENCE{

| | |
|---|---|
| reportConfigId | CSI-ReportConfigId, |

| | |
|---|---|
| carrier | ServCellIndex |

OPTIONAL,

| | |
|---|---|
| resourcesForChannelMeasurement | CSI-ResourceConfigId, |

...

| | |
|---|---|
| representativeCSI-Report | EUMERATED {enabled, disabled}, |

OPTIONAL,

| | | |
|---|---|---|
| memberCSI-ReportList | SEQUENCE of | CSI-ReportConfigId |

OPTIONAL,

| | |
|---|---|
| nrofReportedRS | ENUMERATED {n1, n2, n3, n4}, |

```
OPTIONAL,
  ...
}
Phy-ParametersFRX-Diff ::= SEQUENCE {
  ...
```

| | |
|---|---|
| csi-representative-report-config | ENUMERATED {supported}, |

OPTIONAL,
...
}
or
-- in 3GPP TR 38.331 [REF1]
CSI-ReportConfig ::= SEQUENCE{

| | |
|---|---|
| reportConfigId | CSI-ReportConfigId, |

| | |
|---|---|
| carrier | ServCellIndex |

OPTIONAL,

| | |
|---|---|
| resourcesForChannelMeasurement | CSI-ResourceConfigId, |

...

| | |
|---|---|
| representativeCSI-Report | EUMERATED {enabled, disabled}, |

OPTIONAL,

| | |
|---|---|
| memberCSI-ReportList | SEQUENCE { |
| SEQUENCE of | CSI-ReportConfigId, |
| nrofReportedRS | ENUMERATED {n1, n2, n3, n4}, |

| | |
|---|---|
| } | OPTIONAL, |

```
  ...
}
Phy-ParametersFRX-Diff ::= SEQUENCE {
  ...
```

| | |
|---|---|
| csi-representative-report-config | ENUMERATED {supported}, |

OPTIONAL,
...
}

In one alternative, the BS aligns the configuration of each CSI-RS triggering and/or report configuration included in each list. The UE obtains the CSI-RS triggering and/or report configuration from any of the CSI-RS triggering and/or report configuration within the list.
In another alternative, the BS allows the CSI-RS triggering and/or report configurations in each list are conflicted. The UE shall obtain the CSI-RS triggering and/or report configuration from the first CSI-RS triggering and/or report configuration within the list.
In another alternative, the BS allows the CSI-RS triggering and/or report configurations in each list are conflicted. The UE shall obtain the CSI-RS triggering and/or report configuration from the explicitly indicated CSI-RS triggering and/or report configuration within the list.
   In an example, the BS informs the UE the index of the CSI-RS triggering and/or report configuration via higher layer RRC signaling/parameter and/or MAC CE command and/or dynamic DCI based signaling.
      In one example, the BS informs the UE a certain CSI-RS triggering and/or report configuration ID.
      In another example, the BS informs an index of a CSI-RS triggering and/or report configuration, e.g., the k-th element, in the list.
   In another example, the BS informs the UE the index of the CSI-RS triggering and/or report configuration with the CSI-report list configuration.
      In one example, the BS informs the UE a certain CSI-RS triggering and/or report configuration ID.
      In another example, the BS informs an index of a CSI-RS triggering and/or report configuration, e.g., the k-th element, in the list.
In one alternative (referred as BM-md2-a), a UE reports top-N measurement(s) with their CSI-RS resource indices and their indices of the CSI-report in the group, and reports the top-N overall CSI-RS resource index together with the measurements.
   In an example shown in Table 4, nrofReportedRS=2 configured by the higher layer configuration, for each CSI-report. Additional index, e.g., “CC-X-b” are included in the CSI-report, where “X” in the index of the CSI-report configuration in one or more methods described herein or the index of the representative and member CSI-ReportConfig(s) or CSI-ResourceConfig(s) in one or more methods described herein; and “b” is the CRI index in the report in range [1, nrofReportedRS]. Such component carrier index required

$$⌈ {log}_{2} ( {K}_{X}^{CSI - CC} ) ⌉ bits ,$$

where

$${K}_{X}^{CSI - CC}$$

is the number of CSI-report to be combined in one or more methods described herein or the number of representative and member CSI-ReportConfig(s) or CSI-ResourceConfig(s) in one or more methods described herein. CRIs are named as “CRI-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS]. CRI contains

$$⌈ {log}_{2} ( {K}_{X}^{CSI - RS} ) ⌉ bits ,$$

in which

$${K}_{X}^{CSI - RS} ,$$

In an example,

$${K}_{X}^{CSI - RS}$$

is the is the number of CSI-RS resources in the corresponding CSI-report configuration in one or more methods described herein or the number of the CSI-RS resources in the representative and member CSI-ReportConfig(s) or CSI-ResourceConfig(s) in one or more methods described herein.
In another example,

$${K}_{X}^{CSI - RS}$$

is the maximum of the number of CSI-RS resources in the corresponding CSI-report configuration in one or more methods described herein or the number of the CSI-RS resources in the representative and member CSI-ReportConfig(s) or CSI-ResourceConfig(s) in one or more methods described herein.

In table 4, RSRPs are named as “RSRP-X-b”, where “X” in the index of the CSI-report configuration in one or more methods described herein or the index of the representative and member CSI-ReportConfig or CSI-ResourceConfig in one or more methods described herein; and “b” is the CRI index in the report in range [1, nrofReportedRS].

TABLE 4

| CSI-report # | Field | Bitwidth |
|---|---|---|
| CSI-report | CC-X-1 | $⌈ {log}_{2} ( {K}_{s}^{CSI - CC} ) ⌉$ |
| | CC-X-2 | $⌈ {log}_{2} ( {K}_{s}^{CSI - CC} ) ⌉$ |
| | CRI-X-1 | $⌈ {log}_{2} ( {K}_{X}^{CSI - RS} ) ⌉$ |
| | CRI-X-2 | $⌈ {log}_{2} ( {K}_{X}^{CSI - RS} ) ⌉$ |
| | RSRP-X-1 | 7 bits |
| | RSRP-X-2 | 4 bits |

In another example, the component carrier index in Table 4 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative (referred as BM-md2-b), a UE indexes the CSI-RS resource index among the CSI-report configurations. The UE reports the top-N measurements and their overall CSI-RS resource indices.
In an example shown in Table 5, nrofReportedRS=2 configured by the higher layer configuration, for each CSI-report. CRIs are named as “CRI-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS]. CRI contains

$$⌈ {log}_{2} ( {K}_{r}^{CSI - RS} ) ⌉ bits ,$$

in which

$${K}_{r}^{CSI - RS}$$

is the number of CSI-RS resources in the corresponding CSI-report configuration. In Table 5, RSRPs are named as “RSRP-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS].

TABLE 5

| CSI-report # | Field | Bitwidth |
|---|---|---|
| CSI-report | CRI-X-1 | $⌈ {log}_{2} ( {K}_{r}^{CSI - RS} ) ⌉$ |
| | CRI-X-2 | $⌈ {log}_{2} ( {K}_{r}^{CSI - RS} ) ⌉$ |
| | RSRP-X-1 | 7 bits |
| | RSRP-X-2 | 4 bits |

In another example, the component carrier index in Table 5 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative, the BS configures a UE with which bit-format the UE shall use.
In an example, a BS informs a UE the format of the CSI-report through a field in the triggering configuration.
   In an example, a field, e.g., csi-report-format, is added to CSI-AperiodicTriggerState informing the format of the CSI-report group in the list. The csi-report-format can be configured as reportIndex-CRI. The UE reports the group using BM-md2-a; if the csi-report-format is configured as combined-CRI, the UE reports the group using BM-md2-b.

-- in 3GPP TR 38.331 [REF1]
CSI-AperiodicTriggerState ::= SEQUENCE {
...

| | |
|---|---|
| csi-report-format | ENUMERATED {reportIndex-CRI, combined- |

CRI, } OPTIONAL,
...
}

In an example, a BS (e.g., the BS 102) informs a UE the format of the CSI-report through a field in the CSI-report configuration.
   In an example, a field, e.g., csi-report-format, is added to CSI-ReportConfig informing the format of a CSI-report. The csi-report-format can be configured as reportIndex-CRI. The UE reports the group using BM-md2-a; if the csi-report-format is configured as combined-CRI, the UE reports the group using BM-md2-b.

| -- in 3GPP TR 38.331 [REF1] | |
|---|---|
| CSI-ReportConfig ::= SEQUENCE{ | |
| ... | |
| csi-report-format | ENUMERATED {reportIndex -CRI, |
| combined-CRI, } OPTIONAL, | |
| ... | |
| } | |
| Phy-ParametersFRX-Diff ::= SEQUENCE { | |
| ... | |
| csi-representative-resource-config | ENUMERATED {supported}, |

OPTIONAL,
...
}

In another method, a BS indicates enabling/disabling of CSI-RS measurements integration through a flag.

FIG. 23 illustrates a diagram of an example trigger configuration 2300 according to embodiments of the present disclosure. For example, trigger configuration 2300 can be configured by the BS 102 of FIG. 2. This example is for illustration only and other embodiments can be used without departing from the scope of the present disclosure.

In this method, a flag is configured by the BS to indicate the CSI-RS measurement integration to the UE through the control signaling. The integrated CSI-report is shortened than the concatenate of the CSI-reports. For example, in the scenario that the CSI-reports are configured with different component carriers. The BS can utilize one or more methods described herein to combine multiple CSI-reports across a number of component carriers when a CSI-report is needed to across multiple component carrier according to the BS application, for example in JPTA BS.

The alternative and examples herein are illustrated using aperiodic CSI-report. However, one or more methods described herein are not limited to aperiodic CSI-report. One or more methods described herein can also be applied to periodic CSI-report, semi-persistent CSI-reports, etc. In the typical 3GPP specifications, although the periodic CSI-report and semi-persistent CSI-reports configuration associate to single CSI-report, one or more methods described herein are applicable for example when the periodic CSI-report and semi-persistent CSI-reports support multiple CSI-reports. One or more methods described herein are not limited to CSI-RS beam selection, but also for the other CSI-report related functions, e.g., interference measurements, etc.
In one alternative, the BS uses a flag, e.g., CSI-measurement-integration, to the UE for CSI-report integration configuration. When the UE supports the integration and such a flag exists and configured as enabled, the UE integrate the CSI-RS measurements and transmits an integrated CSI-report; otherwise, the UE may not integrate the CSI-RS measurements.
   In an example, a UE reports the capability of CSI-RS measurements integration to the BS. The BS enabling or disabling the CSI-RS measurements integration through higher layer flag that globally configures the triggered CSI-reports.
   With reference to FIG. 23, in an example, a UE reports the capability of CSI-RS measurements integration to the BS. The BS enables or disables the CSI-RS measurements integration through a flag within the configuration of certain CSI-report triggering.

| -- in 3GPP TR 38.331 [REF1] | |
|---|---|
| CSI-AperiodicTriggerState ::= SEQUENCE { | |
| ... | |
| csi-measurement-integration | ENUMERATED {enabled, disabled} |
| OPTIONAL, | |
| ... | |
| } | |
| Phy-ParametersFRX-Diff ::= SEQUENCE { | |
| ... | |
| csi-measurement-integration-config | ENUMERATED {supported}, |

OPTIONAL,
...
}

In one alternative (referred as BM-md3-a), a UE reports top-N measurement(s) with their CSI-RS resource indices and their indices of the CSI-report in the group, and reports the top-N overall CSI-RS resource index together with the measurements.
   In an example shown in Table 6, nrofReportedRS=2 configured by the higher layer configuration, for each CSI-report. Additional index, e.g., “CC-X-b” are included in the CSI-report, where “X” in the index of the CSI-report configuration in one or more methods described herein or the index of the representative and member CSI-ReportConfig(s) or CSI-ResourceConfig(s) in one or more methods described herein; and “b” is the CRI index in the report in range [1, nrofReportedRS]. Such component carrier index required

$$⌈ {log}_{2} ( {K}^{C S I - C C} ) ⌉ bits ,$$

where K^{CSI-CC} is the number of CSI-report to be combined in one or more methods described herein or the number of representative and member CSI-ReportConfig(s) or CSI-ResourceConfig(s) in one or more methods described herein. CRIs are named as “CRI-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS]. CRI contains

$$⌈ {log}_{2} ( {K}_{X}^{C S I - R S} ) ⌉ bits ,$$

in which

$${K}_{X}^{C S I - R S} ,$$

In an example,

$${K}_{X}^{C S I - R S}$$

is the is the number of CSI-RS resources in the corresponding CSI-report configuration in one or more methods described herein or the number of the CSI-RS resources in the representative and member CSI-ReportConfig(s) or CSI-ResourceConfig(s) in one or more methods described herein.
In another example,

$${K}_{X}^{C S I - R S}$$

is the maximum of the number of CSI-RS resources in the corresponding CSI-report configuration in one or more methods described herein or the number of the CSI-RS resources in the representative and member CSI-ReportConfig(s) or CSI-ResourceConfig(s) in one or more methods described herein.

In Table 6, RSRPs are named as “RSRP-X-b”, where “X” in the index of the CSI-report configuration in one or more methods described herein or the index of the representative and member CSI-ReportConfig or CSI-ResourceConfig in one or more methods described herein; and “b” is the CRI index in the report in range [1, nrofReportedRS].

TABLE 6

| CSI-report # | Field | Bitwidth |
|---|---|---|
| CSI-report | CC-X-1 | $⌈ {log}_{2} ( {K}_{s}^{CSI - CC} ) ⌉$ |
| | CC-X-2 | $⌈ {log}_{2} ( {K}_{s}^{CSI - CC} ) ⌉$ |
| | CRI-X-1 | $⌈ {log}_{2} ( {K}_{X}^{CSI - RS} ) ⌉$ |
| | CRI-X-2 | $⌈ {log}_{2} ( {K}_{X}^{CSI - RS} ) ⌉$ |
| | RSRP-X-1 | 7 bits |
| | RSRP-X-2 | 4 bits |

In another example, the component carrier index in Table 6 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative (referred as BM-md3-b), a UE indexes the CSI-RS resource index among the CSI-report configurations. The UE (e.g., the UE 116) reports the top-N measurements and their overall CSI-RS resource indices.
In an example shown in Table 7, nrofReportedRS=2 configured by the higher layer configuration, for each CSI-report. CRIs are named as “CRI-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS]. CRI contains

$$⌈ {log}_{2} ( {K}_{r}^{C S I - R S} ) ⌉ bits ,$$

in which

$${K}_{r}^{C S I - R S}$$

is the number of CSI-RS resources in the corresponding CSI-report configuration. In Table 7, RSRPs are named as “RSRP-X-b”, where “X” in the index of the CSI-report configuration in one or more methods described herein or the index of the representative-member CSI-ReportConfig(s) or CSI-ResourceConfig(s) in one or more methods described herein; and “b” is the CRI index in the report in range [1, nrofReportedRS].

TABLE 7

| CSI-report # | Field | Bitwidth |
|---|---|---|
| CSI-report | CRI-X-1 | $⌈ {log}_{2} ( {K}_{r}^{CSI - RS} ) ⌉$ |
| | CRI-X-2 | $⌈ {log}_{2} ( {K}_{r}^{CSI - RS} ) ⌉$ |
| | RSRP-X-1 | 7 bits |
| | RSRP-X-2 | 4 bits |

In another example, the component carrier index in Table 7 can be any index that can identify the CSI-RS resources to be reported, for example, CSI-report configuration index or CSI-ReportConfigId, CSI-RS resource configuration indexing or CSI-resourceConfigId, component carrier indexing or ServCellIndex.
In another alternative, the BS configures a UE with which bit-format the UE shall use.
In an example, a BS informs a UE the format of the CSI-report through a field in the triggering configuration.
In an example, a field, e.g., csi-report-format, is added to CSI-AperiodicTriggerState informing the format of the CSI-report group in the list. The csi-report-format can be configured as reportIndex-CRI. The UE reports the group using BM-md3-a; if the csi-report-format is configured as combined-CRI, the UE reports the group using BM-md3-b.

-- in 3GPP TR 38.331 [REF1]
CSI-AperiodicTriggerState ::= SEQUENCE {
...

| | |
|---|---|
| csi-report-format | ENUMERATED {reportIndex-CRI, combined- |

CRI, } OPTIONAL,
...
}

In an example, a BS informs a UE the format of the CSI-report through a field in the CSI-report configuration.
   In an example, a field, e.g., csi-report-format, is added to CSI-ReportConfig informing the format of a CSI-report. The csi-report-format can be configured as reportIndex-CRI. The UE reports the group using BM-md3-a; if the csi-report-format is configured as combined-CRI, the UE reports the group using BM-md3-b.

| -- in 3GPP TR 38.331 [REF1] | |
|---|---|
| CSI-ReportConfig ::= SEQUENCE{ | |
| ... | |
| csi-report-format | ENUMERATED {reportIndex-CRI, |
| combined-CRI, } OPTIONAL, | |
| ... | |
| } | |
| Phy-ParametersFRX-Diff ::= SEQUENCE { | |
| ... | |
| csi-representative-resource-config | ENUMERATED {supported}, |

OPTIONAL,
...
}

In another embodiment, a BS configures UE to integrate multiple CSI-RS measurements from multiple CCs into multiple groups of measurements and to derive one report per group: The BS informs the UE multiple groups of measurements to integrate, e.g., via RRC. The UE reports the N-highest measurements and corresponding resource indices (including the resource indices corresponds to the CC indices) from the multiple measurements in each group. A method is introduced as follows to indicate CSI-report grouping to the UE.

In another method, a BS indicates multiple grouping configurations of multiple CSI-reports on multiple CCs.

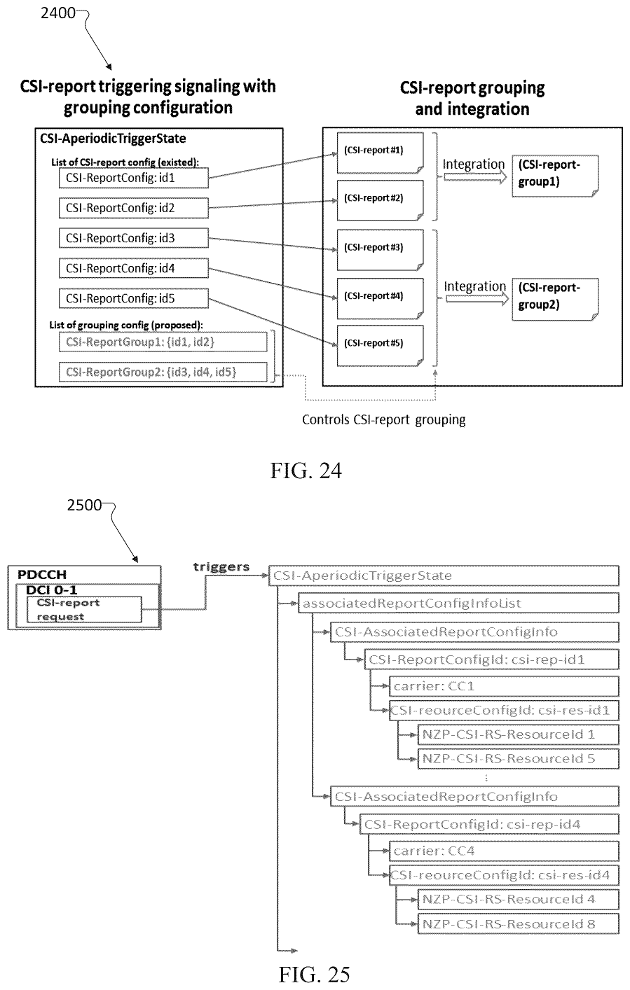

FIG. 24 illustrates a diagram of an example CSI report trigger configuration 2400 according to embodiments of the present disclosure. For example, CSI report trigger configuration 2400 can be configured by the BS 102 of FIG. 1. This example is for illustration only and other embodiments can be used without departing from the scope of the present disclosure.

In this method, the CSI-reports are grouped, and the UE reports one CSI-RS group report per grouped CSI-report. In each group, the CSI-RS resources are selected from the CSI-reports. The grouped CSI-report is shortened than the concatenate of the CSI-reports. The grouping configurations are informed by the BS to the UE through control signaling. For example, in the scenario that the CSI-reports are configured with different component carriers. The BS can utilize one or more methods described herein to combine multiple CSI-reports across a number of component carriers when a CSI-report is needed to across multiple component carrier according to the BS application, for example in JPTA BS.

With reference to FIG. 24, the UE is triggered to measure CSI-RS measurements with 5 CSI-report configurations as shown. Each CSI-report configuration associates to a certain CC. The CCs associated to the 4 CSI-report configures can be the same or different. Besides of the CSI-report configurations, the BS configures 2 CSI-report groups. The first group is associated to the first 2 CSI-report configurations and the second group is associated to the rest 4 CSI-report configurations. The UE measures the CSI-RS resources in the associated CCs according to the 5 CSI-report configurations. Then, the UE groups the CSI-RS measurements according to the group configuration, i.e., the CSI-RS measurements associated to the first 2 CSI-report configurations are integrated in group 1; the CSI-RS measurements associated to the rest 3 CSI-report configurations are integrated in group 2. The UE transmits two CSI-reports to the BS (e.g., the BS 102) as configured two CSI-report grouping.

The alternatives and examples herein are illustrated using aperiodic CSI-report. However, one or more methods described herein are not limited to aperiodic CSI-report. One or more methods described herein can also be applied to periodic CSI-report, semi-persistent CSI-reports, etc. In the typical 3GPP specifications, although the periodic CSI-report and semi-persistent CSI-reports configuration associate to single CSI-report, one or more methods described herein is applicable, for example, when the periodic CSI-report and semi-persistent CSI-reports support multiple CSI-reports. One or more methods described herein are not limited to CSI-RS beam selection, but also for the other CSI-report related functions, e.g., interference measurements, etc.

FIG. 25 illustrates a diagram of an example trigger configuration 2500 according to embodiments of the present disclosure. For example, trigger configuration 2500 can be configured by the BS 103 of FIG. 1. This example is for illustration only and other embodiments can be used without departing from the scope of the present disclosure.

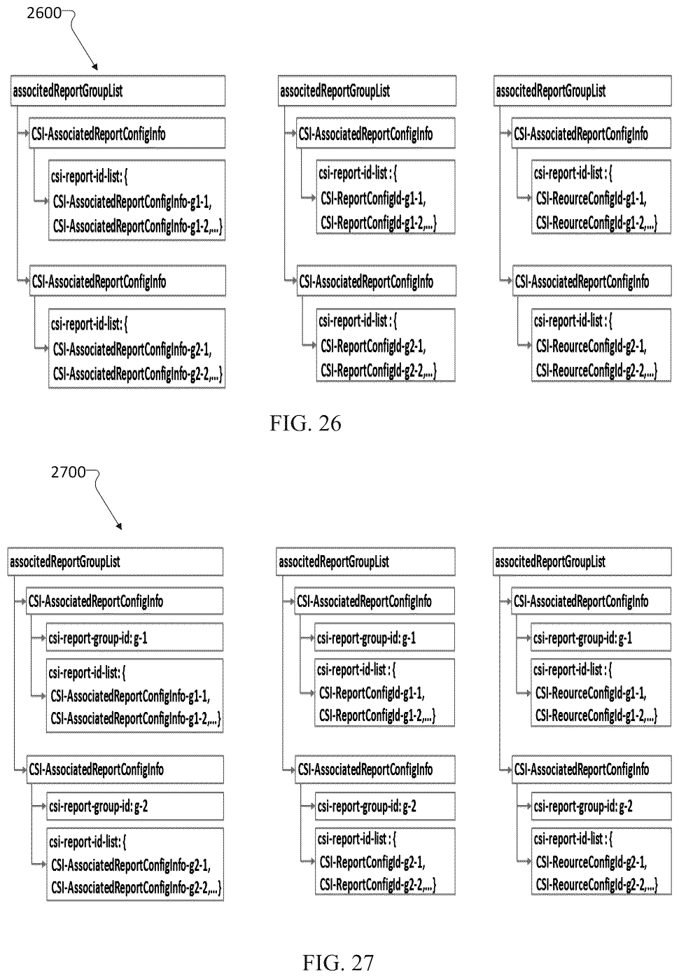

FIG. 26 illustrates a diagram of example CSI report group configurations 2600 according to embodiments of the present disclosure. For example, CSI report group configurations 2600 can be implemented by any of the UEs 111-116 of FIG. 1, such as the UE 114. This example is for illustration only and other embodiments can be used without departing from the scope of the present disclosure.

FIG. 27 illustrates a diagram of example CSI report group configurations 2700 according to embodiments of the present disclosure. For example, CSI report group configurations 2700 can be implemented by any of the UEs 111-116 of FIG. 1, such as the UE 115. This example is for illustration only and other embodiments can be used without departing from the scope of the present disclosure.

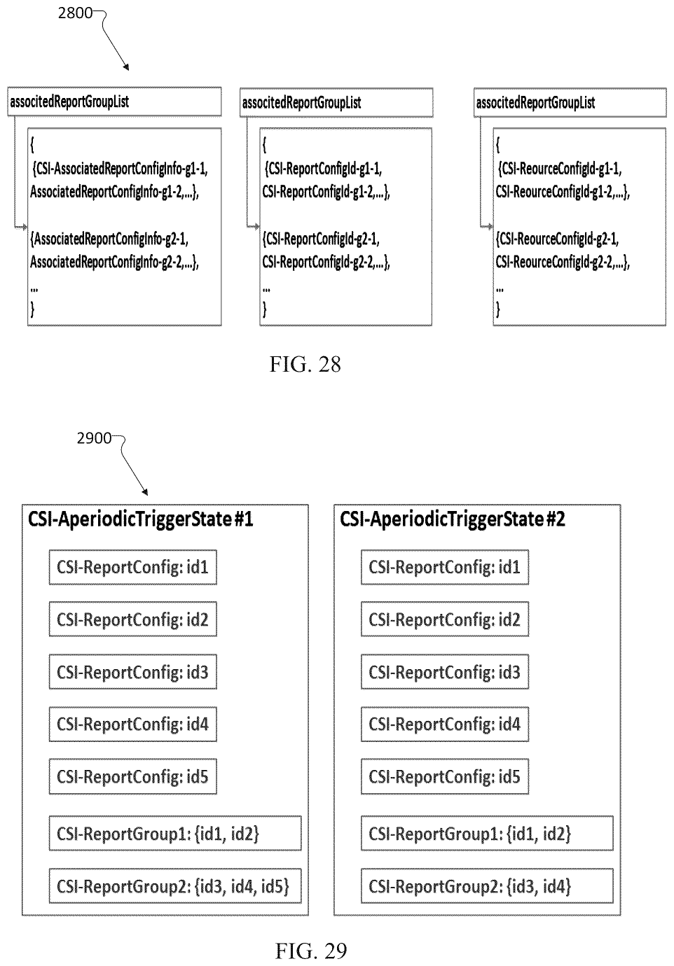

FIG. 28 illustrates a diagram of example CSI report group configurations 2800 according to embodiments of the present disclosure. For example, CSI report group configurations 2800 can be implemented by any of the UEs 111-116 of FIG. 1, such as the UE 111. This example is for illustration only and other embodiments can be used without departing from the scope of the present disclosure.

With reference to FIG. 15, to illustrate the following alternative and examples in this method, the example of transmitted 8 CSI-RS beams with JPTA BS is used as shown. The alternatives and examples of the control signaling are demonstrated herein.
In one alternative, the grouping configuration is informed in the CSI-report triggering configuration, i.e., CSI-AperiodicTriggerState. With reference to FIG. 25, in an example, a new field, for example named as associatedReportGroupList, is added to CSI-AperiodicTriggerState informs the CSI-report grouping configuration as shown. The grouped CSI-reports are informed in the existing field associatedReportConfigInfoList.
   In an example, the new added field to CSI-AperiodicTriggerState, e.g., associatedReportGroupList contains a sequence of CSI-report group configurations, e.g., CSI-AssociatedReportConfigInfo:
      With reference to FIG. 26 (and according to one or more figures described herein), in an example, each CSI-report group configuration contains a list of indices to inform a UE the index of the CSI-AssociatedReportConfigInfo, CSI-ReportConfigId, CSI-resourceConfigId, binary index of the existing AssociatedReportConfigInfo or CSI-ReportConfigId or CSI-resourceConfigId, etc.:

-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| | | |
|---|---|---|
| csi-report-id-list | SEQUENCE OF | CSI- |

AssociatedReportConfigInfo,

| | |
|---|---|
| } | OPTIONAL |

or
-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| | | |
|---|---|---|
| csi-report-id-list | SEQUENCE OF | CSI-ReportConfigId, |

| | |
|---|---|
| } | OPTIONAL |

or
-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| | | |
|---|---|---|
| csi-report-id-list | SEQUENCE OF | CSI-resourceConfigId, |

| | |
|---|---|
| } | OPTIONAL |

With reference to FIG. 27 (and according to one or more figures described herein), in another example, each CSI-report group configurations contains a group index, e.g., group-id. Besides, each CSI-report group configuration contains a list of indices to inform a UE the index of the CSI-AssociatedReportConfigInfo, CSI-ReportConfigId, CSI-resourceConfigId, binary index of the existing AssociatedReportConfigInfo or CSI-ReportConfigId or CSI-resourceConfigId, etc., as shown:

-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| csi-report-group-id | CSI-ReportGroupId, | |
|---|---|---|
| csi-report-id-list | SEQUENCE OF | CSI- |

AssociatedReportConfigInfo,

| | |
|---|---|
| } | OPTIONAL |

CSI-ReportGroupId ::= INTEGER (0..maxNrofCSI-ReportGroups−1)
or
-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| csi-report-group-id | CSI-ReportGroupId, | |
|---|---|---|
| csi-report-id-list | SEQUENCE OF | CSI-resourceConfigId, |

| | |
|---|---|
| } | OPTIONAL |

CSI-ReportGroupId ::= INTEGER (0..maxNrofCSI-ReportGroups−1)
or
-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| csi-report-group-id | CSI-ReportGroupId, | |
|---|---|---|
| csi-report-id-list | SEQUENCE OF | CSI-resourceConfigId, |

| | |
|---|---|
| } | OPTIONAL |

CSI-ReportGroupId ::= INTEGER (0..maxNrofCSI-ReportGroups−1)

With reference to FIG. 28 (and according to one or more figures described herein), in another example, the new added field to CSI-AperiodicTriggerState, e.g., associatedReportGroupList contains a list of lists. Each element in the list contains a list of indices to inform a UE (e.g., the UE 116) the index of the CSI-reports. Such list of indices can be a list of CSI-AssociatedReportConfigInfo, CSI-ReportConfigId, CSI-resourceConfigId, binary index of the existing AssociatedReportConfigInfo or CSI-ReportConfigId or CSI-resourceConfigId, etc., as shown:

-- in 3GPP TR 38.331 [REF1]
CSI-AperiodicTriggerState ::= SEQUENCE {
...

| associatedReportGroupList | SEQUENCE { | |
|---|---|---|
| csi-report-id-list | SEQUENCE OF | CSI- |

AssociatedReportConfigInfo,

| | |
|---|---|
| } | OPTIONAL, |

```
  ...
}
or
-- in 3GPP TR 38.331 [REF1]
CSI-AperiodicTriggerState ::= SEQUENCE {
  ...
```

| associatedReportGroupList | SEQUENCE { | |
|---|---|---|
| csi-report-id-list | SEQUENCE OF | CSI- |

ReportConfigId,

| | |
|---|---|
| } | OPTIONAL, |

```
  ...
}
or
-- in 3GPP TR 38.331 [REF1]
CSI-AperiodicTriggerState ::= SEQUENCE {
  ...
```

| associatedReportGroupList | SEQUENCE { | |
|---|---|---|
| csi-report-id-list | SEQUENCE OF | CSI- |

resourceConfigId,

| | |
|---|---|
| } | OPTIONAL, |

...
}

In one alternative, the BS aligns the configuration of each CSI-RS triggering and/or report configuration included in each group. The UE obtains the CSI-RS triggering and/or report configuration from any of the CSI-RS triggering and/or report configuration within the group.
In another alternative, the BS allows the CSI-RS triggering and/or report configurations in each group are conflicted. The UE shall obtain the CSI-RS triggering and/or report configuration from the first CSI-RS triggering and/or report configuration within the group.
In another alternative, the BS allows the CSI-RS triggering and/or report configurations in each group are conflicted. The UE shall obtain the CSI-RS triggering and/or report configuration from the explicitly indicated CSI-RS triggering and/or report configuration within the group.
   In an example, the BS informs the UE the index of the CSI-RS triggering and/or report configuration via higher layer RRC signaling/parameter and/or MAC CE command and/or dynamic DCI based signaling.
      In one example, the BS informs the UE a certain CSI-RS triggering and/or report configuration ID.
      In another example, the BS informs an index of a CSI-RS triggering and/or report configuration, e.g., the k-th element, in the group or list.
   In another example, the BS informs the UE the index of the CSI-RS triggering and/or report configuration with the CSI-report grouping configuration.
      In one example, the BS informs the UE a certain CSI-RS triggering and/or report configuration ID.
      In another example, the BS informs an index of a CSI-RS triggering and/or report configuration, e.g., the k-th element, in the group or list.

FIG. 29 illustrates a diagram of example CSI report group configurations 2900 according to embodiments of the present disclosure. For example, CSI report group configurations 2900 can be implemented by the UE 116 of FIG. 3. This example is for illustration only and other embodiments can be used without departing from the scope of the present disclosure.

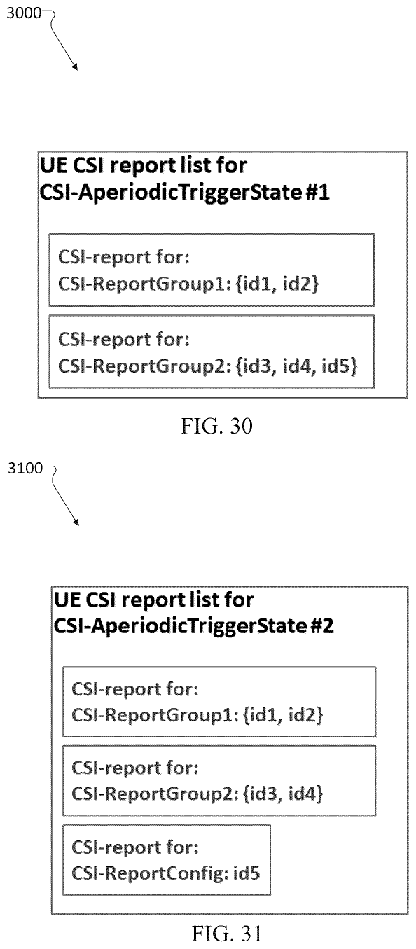

FIG. 30 illustrates a diagram of an example CSI report list configuration 3000 according to embodiments of the present disclosure. For example, CSI report list configuration 3000 can be implemented by any of the UEs 111-116 of FIG. 1, such as the UE 113. This example is for illustration only and other embodiments can be used without departing from the scope of the present disclosure.

FIG. 31 illustrates a diagram of an example CSI report list configuration 3100 according to embodiments of the present disclosure. For example, CSI report list configuration 3100 can be implemented by any of the UEs 111-116 of FIG. 1, such as the UE 114. This example is for illustration only and other embodiments can be used without departing from the scope of the present disclosure.

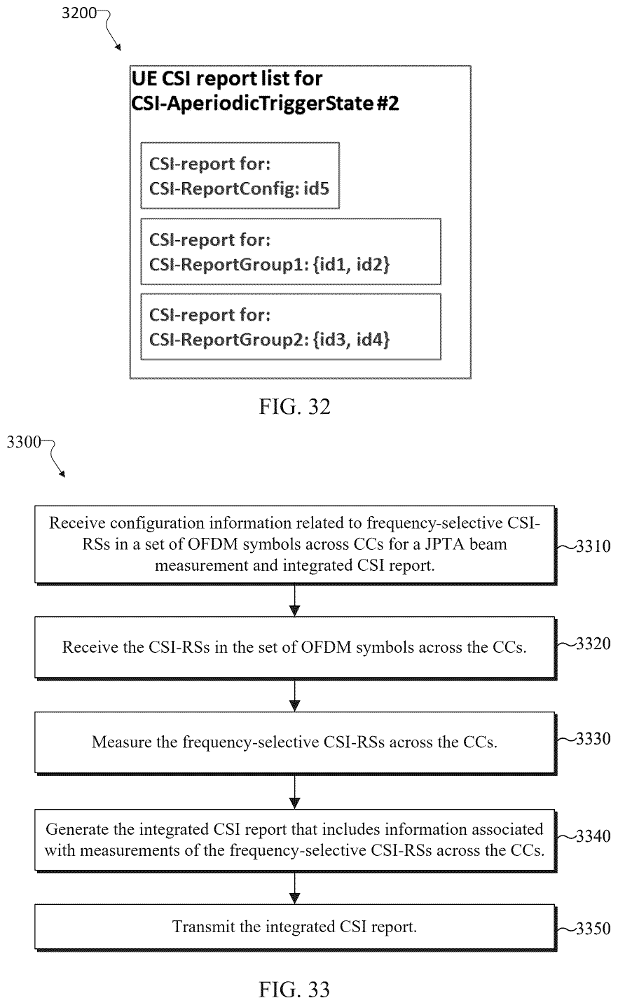

FIG. 32 illustrates a diagram of an example CSI report list configuration 3200 according to embodiments of the present disclosure. For example, CSI report list configuration 3200 can be implemented by any of the UEs 111-116 of FIG. 1, such as the UE 115. This example is for illustration only and other embodiments can be used without departing from the scope of the present disclosure.

With reference to FIG. 29, for illustration purpose, two examples of CSI-report group configuration are shown, identified by CSI-AperiodicTriggerStage “#1” and “#2”. In both examples, 5 CSI-ReportConfig are included in the CSI-AperiodicTriggerStage. In CSI-AperiodicTriggerStage “#1”, CSI-ReportConfig “id1” to “id5” are included in two CSI-ReportGroup. Differently, in CSI-AperiodicTriggerStage “#1”, only CSI-ReportConfig “id1” to “id4” are included in two CSI-ReportGroup, while CSI-ReportConfig “id5” may not be included in any of the CSI-ReportGroup. With reference to FIG. 29, the alternatives of UE CSI-reporting alternatives in one or more methods described herein are demonstrated using the two examples.
In one alternative, if the CSI-report group list, e.g., associatedReportGroupList, existed in or informed by the CSI-RS triggering IE, e.g., CSI-AperiodicTriggerState, the CSI-reportConfig informed by CSI-AssociatedReportConfigInfo shall be included in one or more CSI-report group(s), i.e., the CSI-AperiodicTriggerState #1 in FIG. 29 is a possible configuration but the CSI-AperiodicTriggerState #2 in FIG. 29 is not desirable due to CSI-ReportConfig id5 is not included in any of the CSI-report groups. Meanwhile, CSI-reportConfig informed in the CSI-report group(s) shall be informed in the CSI-AperiodicTriggerState. With reference to FIG. 30, the CSI-reports are in the report sequence that correspond to the CSI-report groups, as shown.
   In an example, each of the CSI-reportConfig informed by associatedReportGroupList can only exist in one CSI-report group informed by the same associatedReportGroupList.
   In another example, each of the CSI-reportConfig informed by associatedReportGroupList can exist in one or multiple CSI-report group informed by the same associatedReportGroupList. UE groups the CSI-report according to the CSI-reports informed in the configuration.
      In an example, the BS (e.g., the BS 102) informs the UE if the CSI-reportConfig can exist in multiple CSI-report group. For instance:

| -- in 3GPP TR 38.331 [REF1] | |
|---|---|
| CSI-AperiodicTriggerState ::= SEQUENCE { | |
| ... | |
| associatedReportGroupList | SEQUENCE OF |
| AssociatedReportConfigInfo OPTIONAL, | |
| associatedReportUniqueInGroups | BOOLEAN |

OPTIONAL,
...
}

In another alternative, if the CSI-report group list, e.g., associatedReportGroupList, existed in or informed by the CSI-RS triggering IE, e.g., CSI-AperiodicTriggerState, partial of the CSI-reportConfig informed by CSI-AssociatedReportConfigInfo are included in one or more CSI-report group(s); the other CSI-reportConfig informed by CSI-AssociatedReportConfigInfo are not included in any CSI-report group, i.e., both the CSI-AperiodicTriggerState #1 and #2 in FIG. 29 are possible configurations. Meanwhile, CSI-reportConfig informed in the CSI-report group(s) shall be informed in the CSI-AperiodicTriggerState.
   For the CSI-report(s) exist in any of the CSI-report group, a UE may not include that or those CSI-report(s) to the BS.
   For the CSI-report(s) may not exist in any of the CSI-report group, a UE includes that or those CSI-report(s) to the BS. For the location of the CSI-report(s) may not exist in any of the CSI-report group:
      With reference to FIG. 31, in an example, the CSI-reports are in the report sequence that ahead of the CSI-report groups as shown.
      With reference to FIG. 32, in another example, the CSI-reports are in the report sequence that after of the CSI-report groups as shown.
In one alternative (referred as bit-format alternative-a of one or more methods described herein, BM-md4-a), a UE reports top-N measurement(s) with their CSI-RS resource indices and their indices of the CSI-report in the group, and reports the top-N overall CSI-RS resource index together with the measurements.
   In an example shown in Table 8, nrofReportedRS=2 configured by the higher layer configuration, for each CSI-report. Additional index, e.g., “CC-X-b” are included in the CSI-report, where “X” in the index of the CSI-report configuration in one or more methods described herein or the index of the representative and member CSI-ReportConfig(s) or CSI-ResourceConfig(s) in this method; and “b” is the CRI index in the report in range [1, nrofReportedRS]. Such component carrier index required

$$⌈ {log}_{2} ( {K}_{X}^{C S I - C C} ) ⌉ bits ,$$

where

$${K}_{X}^{CSI - CC}$$

is the number of CSI-report to be combined in this method or the number of representative and member CSI-ReportConfig(s) or CSI-ResourceConfig(s) in this method. CRIs are named as “CRI-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS]. CRI contains

$$⌈ {log}_{2} ( {K}_{X}^{C S I - R S} ) ⌉ bits ,$$

in which

$${K}_{X}^{C S I - R S} ,$$

In an example,

$${K}_{X}^{C S I - R S}$$

is the is the number of CSI-RS resources in the corresponding CSI-report configuration in one or more methods described herein or the number of the CSI-RS resources in the representative and member CSI-ReportConfig(s) or CSI-ResourceConfig(s) in this method.
In another example,

$${K}_{X}^{C S I - R S}$$

is the maximum of the number of CSI-RS resources in the corresponding CSI-report configuration in one or more methods described herein or the number of the CSI-RS resources in the representative and member CSI-ReportConfig(s) or CSI-ResourceConfig(s) in this method.

In Table 8, RSRPs are named as “RSRP-X-b”, where “X” in the index of the CSI-report configuration in one or more methods described herein or the index of the representative and member CSI-ReportConfig or CSI-ResourceConfig in this method; and “b” is the CRI index in the report in range [1, nrofReportedRS].

TABLE 8

| CSI-report # | Field | Bitwidth |
|---|---|---|
| CSI-report | CC-X-1 | $⌈ {log}_{2} ( {K}_{s}^{CSI - CC} ) ⌉$ |
| | CC-X-2 | $⌈ {log}_{2} ( {K}_{s}^{CSI - CC} ) ⌉$ |
| | CRI-X-1 | $⌈ {log}_{2} ( {K}_{X}^{CSI - RS} ) ⌉$ |
| | CRI-X-2 | $⌈ {log}_{2} ( {K}_{X}^{CSI - RS} ) ⌉$ |
| | RSRP-X-1 | 7 bits |
| | RSRP-X-2 | 4 bits |

In another example, the component carrier index in Table 8 can be any index that can identify the CSI-RS resources to be reported, for example, CSI-RS associated report configuration information indexing or AssociatedReportConfigInfo, CSI-report configuration index or CSI-ReportConfigId, CSI-RS resource configuration indexing or CSI-resourceConfigId, component carrier indexing or ServCellIndex.
In another alternative (referred as BM-md4-b), a UE indexes the CSI-RS resource index among the CSI-report configurations. The UE reports the top-N measurements and their overall CSI-RS resource indices.
In an example shown in Table 9, nrofReportedRS=2 configured by the higher layer configuration, for each CSI-report. CRIs are named as “CRI-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS]. CRI contains

$$⌈ {log}_{2} ( {K}_{r}^{C S I - R S} ) ⌉ bits ,$$

in which

$${K}_{r}^{C S I - R S}$$

is the number of CSI-RS resources in the corresponding CSI-report configuration. In Table 9, RSRPs are named as “RSRP-X-b”, where “X” in the index of the CSI-report configuration in one or more methods described herein or the index of the representative-member CSI-ReportConfig(s) or CSI-ResourceConfig(s) in this method; and “b” is the CRI index in the report in range [1, nrofReportedRS].

TABLE 9

| CSI-report # | Field | Bitwidth |
|---|---|---|
| CSI-report | CRI-X-1 | $⌈ {log}_{2} ( {K}_{r}^{CSI - RS} ) ⌉$ |
| | CRI-X-2 | $⌈ {log}_{2} ( {K}_{r}^{CSI - RS} ) ⌉$ |
| | RSRP-X-1 | 7 bits |
| | RSRP-X-2 | 4 bits |

In another example, the component carrier index in Table 9 can be any index that can identify the CSI-RS resources to be reported, for example, CSI-RS associated report configuration information indexing or AssociatedReportConfigInfo, CSI-report configuration index or CSI-ReportConfigId, CSI-RS resource configuration indexing or CSI-resourceConfigId, component carrier indexing or ServCellIndex.
In another alternative, the BS configures a UE with which bit-format the UE shall use.
In an example, a BS informs a UE the format of the CSI-report through a field in the triggering configuration.
   In an example, a field, e.g., csi-report-format, is added to AssociatedReportConfigInfo informing the format of a CSI-report group. The csi-report-format can be configured as reportIndex-CRI. The UE reports the group using BM-md4-a; if the csi-report-format is configured as combined-CRI, the UE reports the group using BM-md4-b.

-- in 3GPP TR 38.331 [REF1]
CSI-AperiodicTriggerState ::= SEQUENCE {
...

| | |
|---|---|
| associatedReportGroupList | SEQUENCE OF |

AssociatedReportConfigInfo OPTIONAL,
...
}
AssociatedReportConfigInfo ::= SEQUENCE {

| | | |
|---|---|---|
| csi-report-id-list | SEQUENCE OF | CSI-ReportConfigId, |

| | |
|---|---|
| csi-report-format | ENUMERATED {reportIndex-CRI, combined- |

CRI, }

| | |
|---|---|
| } | OPTIONAL |

In an example, a field, e.g., csi-report-format, is added to associatedReportGroupList informing the format of the CSI-report group in the list. The csi-report-format can be configured as reportIndex-CRI. The UE reports the group using BM-md4-a; if the csi-report-format is configured as combined-CRI, the UE reports the group using BM-md4-b.

-- in 3GPP TR 38.331 [REF1]
CSI-AperiodicTriggerState ::= SEQUENCE {
...

| | |
|---|---|
| associatedReportGroupList | SEQUENCE{ |
| SEQUENCE OF | AssociatedReportConfigInfo |
| csi-report-format | ENUMERATED {reportIndex -CRI, |

combined-CRI, }

| | |
|---|---|
| } | OPTIONAL, |

...
}

In an example, a field, e.g., csi-report-format, is added to CSI-AperiodicTriggerState informing the format of the CSI-report group in the list. The csi-report-format can be configured as reportIndex-CRI. The UE reports the group using BM-md4-a; if the csi-report-format is configured as combined-CRI, the UE reports the group using BM-md4-b.

-- in 3GPP TR 38.331 [REF1]
CSI-AperiodicTriggerState ::= SEQUENCE {
...

| | |
|---|---|
| csi-report-format | ENUMERATED {reportIndex-CRI, combined- |

CRI, } OPTIONAL,
...
}

In one embodiment, a CSI-report with CSI-RS resources on multiple CCs for BM in hybrid or fully-digital system is provided.

One or more embodiments described herein are applicable to hybrid beamforming or fully-digital system. Each CSI-report configuration is associated with one or multiple CSI-RS resources across one or multiple component carrier(s). A UE (e.g., the UE 116) generated an integrated CSI-report from one or multiple CSI-RS measurement(s) across the component carrier(s) in hybrid or fully-digital system.
In one alternative, the BS performs FR2-style BM and transmit digital/hybrid beam per CSI-RS resource and requests report quantity(s), for example CRI-RSRP or SSB-index-RSRP. One or more methods described herein can be applied directly to the scenario. The CSI-reports are configured to be grouped and pre-selected by the UE, or one CSI-report is associated CSI-RS resources to one or multiple component carrier(s).
In another alternative, the BS performs FR1-style BM and transmit precoded/non-precoded digital/hybrid beam per CSI-RS port, and requests report quantity of but not limited to CSI-RS Resource Indicator, rank indicator (RI), layer indicator, precoder index, channel quality information, etc., e.g., channel quality indicator report interval (CRI)-RI-precoding matrix indicator (PMI)-channel quality indicator (CQI), CRI-RI-il, CRI-RI-il-CQI, CRI-RI-CQI, CRI-RI-layer index (LI)-PMI-CQI, etc. in 5G new radio specifications. One or more methods described herein can be applied directly with the requested report quantities according to the configuration.

FIG. 33 illustrates an example method 3300 performed by a UE in a wireless communication system according to embodiments of the present disclosure. The method 3300 of FIG. 33 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3300 is for illustration only and other embodiments can be used without departing from the scope of the present disclosure.

The method 3300 begins with the UE receiving configuration information related to frequency-selective CSI-RSs in a set of OFDM symbols across CCs for a JPTA beam measurement and integrated CSI report (3310). For example, in 3310, the configuration information may further indicate that the CCs are partitioned into multiple groups and the integrated CSI report includes information associated with the N CSI-RS measurements for CSI-RSs from the multiple groups.

In various embodiments, the UE may also receive an indication enabling or disabling the integrated CSI report. For example, integrated CSI reporting may be explicitly requested. In other examples, integrated CSI reporting may be implicitly requested or used as a default for JPTA beam measurement and reporting.

The UE then receives the CSI-RSs in the set of OFDM symbols across the CCs (3320). For example, in 3320, the CSI-RSs reception may be based on the configuration information. The UE then measures the frequency-selective CSI-RSs across the CCs (3330). For example, in 3330, the measurement may be based on the configuration information.

The UE then generates the integrated CSI report that includes information associated with measurements of the frequency-selective CSI-RSs across the CCs (3340). The UE then transmits the integrated CSI report (3350).

In various embodiments, the UE may select N CSI-RS measurements based on a measurement quantity from the frequency-selective CSI-RSs measured across the CCs for reporting in the integrated CSI report. For example, configuration information may further indicate that the CCs are partitioned into multiple groups and the integrated CSI report includes information associated with the N CSI-RS measurements for CSI-RSs from the multiple groups.

In various embodiments, the configuration information further indicates that the CCs are partitioned into groups, each group from the groups is associated with a set of beams, and the integrated CSI report indicates measurements from each of the groups of CCs. In various embodiments, the configuration information further indicates that the CCs are partitioned into groups, the UE generates a CSI report for each of the groups that includes information associated with N CSI-RS measurements for the respective group, and the integrated CSI report includes the CSI report for each of the groups. In various embodiments, the integrated CSI report, based on the configuration information, includes multiple CSI reports when a number of the CCs exceeds a threshold, and each of the multiple CSI reports corresponds to a subset of the CCs.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information related to (i) frequency-selective channel state information reference signals (CSI-RSs) in a set of orthogonal frequency-division multiplexing (OFDM) symbols across component carriers (CCs) for a joint phase-time array (JPTA) beam measurement and (ii) integrated channel state information (CSI) report; and
receive, based on the configuration information, the frequency-selective CSI-RSs in the set of OFDM symbols across the CCs; and
a processor operably coupled with the transceiver, the processor configured to:
measure, based on the configuration information, the frequency-selective CSI-RSs across the CCs; and
generate the integrated CSI report that includes information associated with measurements of the frequency-selective CSI-RSs across the CCs,
wherein the transceiver is further configured to transmit the integrated CSI report.

2. The UE of claim 1, wherein the processor is further configured to select N CSI-RS measurements based on a measurement quantity from the frequency-selective CSI-RSs measured across the CCs for reporting in the integrated CSI report.

3. The UE of claim 2, wherein:
the configuration information further indicates that the CCs are partitioned into multiple groups, and
the integrated CSI report includes information associated with the N CSI-RS measurements for CSI-RSs from the multiple groups.

4. The UE of claim 1, wherein:
the configuration information further indicates that the CCs are partitioned into groups,
each group from the groups is associated with a set of beams, and
the integrated CSI report indicates measurements from each of the groups of CCs.

5. The UE of claim 1, wherein:
the configuration information further indicates that the CCs are partitioned into groups,
the processor is further configured to generate a CSI report for each of the groups that includes information associated with N CSI-RS measurements for the respective group, and
the integrated CSI report includes the CSI report for each of the groups.

6. The UE of claim 1, wherein:
the integrated CSI report, based on the configuration information, includes multiple CSI reports when a number of the CCs exceeds a threshold, and
each of the multiple CSI reports corresponds to a subset of the CCs.

7. The UE of claim 1, wherein the transceiver is further configured to receive an indication enabling or disabling the integrated CSI report.

8. Abase station (BS), comprising:
a processor; and
a transceiver operably coupled with the processor, the transceiver configured to:
transmit configuration information related to (i) frequency-selective channel state information reference signals (CSI-RSs) in a set of orthogonal frequency-division multiplexing (OFDM) symbols across component carriers (CCs) for a joint phase-time array (JPTA) beam measurement and (ii) integrated channel state information (CSI) report;
transmit, according to the configuration information, the frequency-selective CSI-RSs in the set of OFDM symbols across the CCs; and
receive the integrated CSI report that includes measurement information associated with the frequency-selective CSI-RSs across the CCs.

9. The BS of claim 8, wherein N CSI-RS measurements are included in the integrated CSI report based on a measurement quantity from the frequency-selective CSI-RSs measured across the CCs.

10. The BS of claim 9, wherein:
the configuration information further indicates that the CCs are partitioned into multiple groups, and
the integrated CSI report includes information associated with the N CSI-RS measurements for CSI-RSs from the multiple groups.

11. The BS of claim 8, wherein:
the configuration information further indicates that the CCs are partitioned into groups,
each group from the groups is associated with a set of beams, and
the integrated CSI report indicates measurements from each of the groups of CCs.

12. The BS of claim 8, wherein:
the configuration information further indicates that the CCs are partitioned into groups, and
the integrated CSI report includes a CSI report for each of the groups that includes information associated with N CSI-RS measurements for the respective group.

13. The BS of claim 8, wherein:
the integrated CSI report, according to the configuration information, includes multiple CSI reports when a number of the CCs exceeds a threshold, and
each of the multiple CSI reports corresponds to a subset of the CCs.

14. The BS of claim 8, wherein the transceiver is further configured to transmit an indication enabling or disabling the integrated CSI report.

15. A method performed by a user equipment (UE), the method comprising:
receiving configuration information related to (i) frequency-selective channel state information reference signals (CSI-RSs) in a set of orthogonal frequency-division multiplexing (OFDM) symbols across component carriers (CCs) for a joint phase-time array (JPTA) beam measurement and (ii) integrated channel state information (CSI) report;
receiving, based on the configuration information, the frequency-selective CSI-RSs in the set of OFDM symbols across the CCs;
measuring, based on the configuration information, the frequency-selective CSI-RSs across the CCs;
generating the integrated CSI report that includes information associated with measurements of the frequency-selective CSI-RSs across the CCs; and
transmitting the integrated CSI report.

16. The method of claim 15, further comprising selecting N CSI-RS measurements based on a measurement quantity from the frequency-selective CSI-RSs measured across the CCs for reporting in the integrated CSI report.

17. The method of claim 16, wherein:
the configuration information further indicates that the CCs are partitioned into multiple groups, and
the integrated CSI report includes information associated with the N CSI-RS measurements for CSI-RSs from the multiple groups.

18. The method of claim 15, wherein:
the configuration information further indicates that the CCs are partitioned into groups,
each group from the groups is associated with a set of beams, and
the integrated CSI report indicates measurements from each of the groups of CCs.

19. The method of claim 15, wherein:
the configuration information further indicates that the CCs are partitioned into groups,
generating the integrated CSI report further comprises generating a CSI report for each of the groups that includes information associated with N CSI-RS measurements for the respective group, and
the integrated CSI report includes the CSI report for each of the groups.

20. The method of claim 15, wherein:
the integrated CSI report, based on the configuration information, includes multiple CSI reports when a number of the CCs exceeds a threshold, and
each of the multiple CSI reports corresponds to a subset of the CCs.
